(19) United States
(12) Patent Application Publication
(10) Pub. No.: US 2019/0037077 A1
(43) Pub. Date: Jan. 31, 2019

(54) System and Method for Customer Experience Automation

(71) Applicant: Genesys Telecommunications Laboratories, Inc., Daly City, CA (US)

(72) Inventors: Yochai Konig, San Francisco, CA (US); James Hvezda, Ancaster (CA); Rotem Maoz, Kohav-Yair (IL); Moshe Mishan, Tel-Aviv (IL); Doron Halevy, Tel-Aviv (IL); Mark W. Stanley, Los Angeles, CA (US)

(21) Appl. No.: 16/151,362

(22) Filed: Oct. 4, 2018

Related U.S. Application Data
(63) Continuation-in-part of application No. 14/201,648, filed on Mar. 7, 2014, now abandoned.
(60) Provisional application No. 62/686,077, filed on Jun. 17, 2018.

(51) Int. Cl. H04M 3/523; H04M 3/51; G10L 13/04; G10L 15/22; G10L 15/18

(52) U.S. Cl. CPC H04M 3/523; H04M 3/5183; H04L 67/306; G10L 15/22; G10L 15/1815; G10L 13/043

(57) ABSTRACT

According to one embodiment, a method for automating an interaction between a user and a contact center includes: receiving, by a processor, a natural language inquiry from the user; identifying, by the processor, a user intent from the natural language inquiry using a natural language processing module; loading, by the processor, a script corresponding to the user intent, the script comprising a plurality of fields of information associated with the user intent; filling at least one of the fields of information of the script based on a stored user profile; and supplying the filled fields of information to the contact center in accordance with the script. Some embodiments of the present invention relate to systems and methods for augmenting interactions between the user and the contact center.

### CROSS-REFERENCE TO RELATED APPLICATION(S)

This application claims the benefit of U.S. Provisional Patent Application No. 62/686,077 “SYSTEM AND METHOD FOR CUSTOMER EXPERIENCE AUTOMATION,” filed in the United States Patent and Trademark Office on Jun. 17, 2018, the entire disclosure of which is incorporated by reference herein. This application is a continuation-in-part of U.S. patent application Ser. No. 14/201,648, “CONVERSATION ASSISTANT,” filed in the United States Patent and Trademark Office on Mar. 7, 2014, the entire disclosure of which is incorporated by reference herein.

### FIELD

Aspects of embodiments of the present invention relate to telecommunications systems and methods, including the automation of aspects of customer service offered through an application executed on a mobile device.

### BACKGROUND

When interacting with large organizations, many existing customer service options rely on interacting with agents of contact centers through voice communications such as telephone calls or text communications such as web-based chat. These interactions generally involve the repetition of standard information, such as a user's personal information, account information, etc. Interacting with contact centers of organizations in this way may also require customers to wait extended periods of time for an agent to become available. Furthermore, these communication channels are generally restricted to voice or text-based communications, thereby constraining the ability of the two parties to communicate and to resolve the customer's issue.

### SUMMARY

Aspects of embodiments of the present invention are directed to systems and methods for automating and/or augmenting portions of interactions between customers and contact centers. The interactions may be conducted over, for example, audio communication channels (e.g., telephone, voice over-IP (VoIP), etc.), video communications channels (e.g., using WebRTC-based video communication, Google® Hangouts®, Skype®, and other video communication technologies), and text-based communication channels (e.g., text chat, instant messaging, text messaging, email, etc). The portions of the interactions that can be automated and/or augmented include periods before, during, after, and between particular interactions.

In one embodiment, a method is presented for automating an interaction between a user and a contact center including: receiving, by a processor, a natural language inquiry from the user; identifying, by the processor, a user intent from the natural language inquiry using a natural language processing module; loading, by the processor, a script corresponding to the user intent, the script including a plurality of fields of information associated with the user intent; filling at least one of the fields of information of the script based on a stored user profile; and supplying the filled fields of information to the contact center in accordance with the script.

The method may further include: prompting the user for data to fill at least one of the fields of information of the script; and receiving the data from the user to fill the at least one of the fields of information. At least one of the fields of information may include user authentication information.

The supplying the filled fields of information may include supplying the filled fields of information to a text-to-speech converter to generate speech and transmitting the generated speech in accordance with an interaction script to a voice communication channel with the contact center. The interaction script may be mined from a plurality of historical interactions between customers and the contact center. The method of supplying the filled fields of information may include transmitting the filled fields of information in accordance with an application programming interface associated with the contact center. The supplying the filled fields of information may also include navigating an interactive voice response system of the contact center.

The method may further include: establishing a communication channel with an agent of the contact center after supplying the filled fields of information to the contact center; and connecting the user to the contact center via the communication channel. The method may also further include detecting an indication from the agent of the contact center that the agent is ready to speak to the user, wherein the connecting the user to the contact center via the communication channel occurs after detecting the indication from the agent of the contact center.

The method may further include displaying one or more recommended actions to the user, wherein the one or more recommended actions may be automatically extracted from a plurality of historical interactions between users and the contact center by: identifying a plurality of interactions having a same user intent; identifying successful and unsuccessful interactions from among the plurality of interactions having the same user intent; identifying characteristics of successful interactions; and generating recommendations based on the identified characteristics of successful interactions.

The one or more fields may include user preferences for agent characteristics. The stored user profile may include a plurality of fields of data, and each field of the stored user profile may be associated with at least one permission setting, the at least one permission setting being set to one of a plurality of sharing levels, the plurality of sharing levels including: share data; share anonymous data; and do not share.

In another embodiment, a method is presented for generating a recommendation to a user during an interaction between the user and an agent of a contact center that includes: receiving, by an end user device of the user, agent speech over a communication channel between the user and the agent of the contact center; converting the agent speech into text of the agent speech; detecting an agent offer in the text of the agent speech; computing a ranking of the agent offer within a plurality of offers in a database of offers; generating a recommendation based the ranking of the agent offer; and displaying, by the end user device of the user, the recommendation to the user.

In another embodiment, a method is presented for retrieving information exchanged during an interaction between a user and an agent of a contact center that includes: receiving one or more query words from a user; searching for the one or more query words in a plurality of transcripts of stored prior interactions between the user and one or more contact centers; identifying one or more matching prior interactions from among the stored prior interactions, wherein at least one of the query words appears in one or more matching transcripts associated with the one or more matching prior interactions; and displaying at least one of the one or more matching transcripts. The one or more matching prior interactions may include at least one document associated with a timestamp within the document, and the method may further include displaying the at least one document when the timestamp corresponds to a portion of the interaction containing the query words.

In yet another embodiment, a method is presented for rating prior interactions including: displaying one or more stored prior interactions; presenting a user interface for rating at least one of the stored prior interactions; and receiving a rating of the at least one of the stored prior interactions via the user interface. The rating may pertain to portions of the at least one of the stored prior interactions.

In yet another embodiment, a system is presented for automating an interaction between a user and a contact center that includes: a processor; a user interface device coupled to the processor; and memory storing instructions that, when executed by the processor, cause the processor to: receive a natural language inquiry from the user via the user interface device; identify a user intent from the natural language inquiry using a natural language processing module; load a script corresponding to the user intent, the script including a plurality of fields of information associated with the user intent; fill at least one of the fields of information of the script based on a stored user profile; and supply the filled fields of information to the contact center in accordance with the script.

The memory may further store instructions that, when executed by the processor, cause the processor to: prompt the user for data to fill at least one of the fields of information of the script via the user interface device; and receive the data from the user to fill the at least one of the fields of information. At least one of the fields of information may include user authentication information.

The instructions that cause the processor to supply the filled fields of information may include instructions that, when executed by the processor, cause the processor to: supply the filled fields of information to a text-to-speech converter to generate speech; and transmit the generated speech in accordance with an interaction script to a voice communication channel with the contact center. The interaction script may be mined from a plurality of historical interactions between customers and the contact center.

The instructions that cause the processor to supply the filled fields of information may include instructions that, when executed by the processor, cause the processor to transmit the filled fields of information in accordance with an application programming interface associated with the contact center. The instructions that cause the processor to supply the filled fields of information may include instructions that, when executed by the processor, cause the processor to navigate an interactive voice response system of the contact center.

The memory may further store instructions that, when executed by the processor, cause the processor to: establish a communication channel with an agent of the contact center after supplying the filled fields of information to the contact center; and connect the user to the contact center via the communication channel. The memory may further store instructions that, when executed by the processor, cause the processor to detect an indication from the agent of the contact center that the agent is ready to speak to the user, wherein the instructions that cause the processor to connect the user to the contact center via the communication channel may be executed after detecting the indication from the agent of the contact center.

The memory may further store instructions that, when executed by the processor, cause the processor to display one or more recommended actions to the user, wherein the one or more recommended actions may be automatically extracted from a plurality of historical interactions between users and the contact center by: identifying a plurality of interactions having a same user intent; identifying successful and unsuccessful interactions from among the plurality of interactions having the same user intent; identifying characteristics of successful interactions; and generating recommendations based on the identified characteristics of successful interactions.

The one or more fields may include user preferences for agent characteristics. The stored user profile may include a plurality of fields of data, and each field of the stored user profile may be associated with at least one permission setting, the at least one permission setting being set to one of a plurality of sharing levels, the plurality of sharing levels including: share data; share anonymous data; and do not share.

In yet another embodiment, a system is presented for generating a recommendation to a user during an interaction between the user and an agent of a contact center including: a processor; and memory storing instructions that, when executed by the processor, cause the processor to: receive agent speech over a communication channel between the user and the agent of the contact center; convert the agent speech into text of the agent speech; detect an agent offer in the text of the agent speech; compute a ranking of the agent offer within a plurality of offers in a database of offers; generate a recommendation based the ranking of the agent offer; and display, on an end user device of the user, the recommendation to the user.

In yet another embodiment, a system is presented for retrieving information exchanged during an interaction between a user and an agent of a contact center including: a processor; and memory storing instructions that, when executed by the processor, cause the processor to: receive one or more query words from a user; search for the one or more query words in a plurality of transcripts of stored prior interactions between the user and one or more contact centers; identify one or more matching prior interactions from among the stored prior interactions, wherein at least one of the query words appears in one or more matching transcripts associated with the one or more matching prior interactions; and display at least one of the one or more matching transcripts.

The one or more matching prior interactions may include at least one document associated with a timestamp within the document, and wherein the memory may further store instructions that, when executed by the processor, cause the processor to display the at least one document when the timestamp corresponds to a portion of the interaction containing the query words.

In yet another embodiment, a system is presented for rating prior interactions that includes: a processor; and memory storing instructions that, when executed by the processor, cause the processor to: display one or more stored prior interactions; present a user interface for rating at least one of the stored prior interactions; and receive a rating of the at least one of the stored prior interactions via the user interface. The rating may pertain to portions of the at least one of the stored prior interactions.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an embodiment of a system block diagram illustrating a system supporting a contact center.

FIG. 2 is an embodiment of a configuration of a block diagram of a pre-call customer experience automation system.

FIG. 3 is an embodiment of a flowchart of a method for automating a pre-call stage of an interaction.

FIG. 4 is an embodiment of diagrams illustrating a landing screen.

FIG. 5 is an embodiment of diagrams illustrating interaction menus.

FIG. 6 is an embodiment of diagrams illustrating a notification.

FIG. 7 is an embodiment of a diagram illustrating examples of searched deals.

FIG. 8 is an embodiment of a diagram illustrating a landing screen.

FIG. 9 is an embodiment of diagrams illustrating a visual interface.

FIG. 10 is an embodiment of a diagram illustrating shared content.

FIG. 11 is an embodiment of diagrams illustrating shared content.

FIG. 12 is an embodiment of diagrams illustrating file share functionality.

FIG. 13 is an embodiment of a diagram illustrating overlay instructions

FIG. 14 is an embodiment of a diagram illustrating a second channel of communication during an interaction.

FIG. 15 is an embodiment of a diagram illustrating a history screen.

FIG. 16 is an embodiment of diagrams illustrating a history screen.

FIG. 17A is an embodiment of diagrams illustrating data sharing control.

FIG. 17B is an embodiment of diagrams illustrating data sharing control.

FIG. 18 is an embodiment of a diagram illustrating data sharing control.

FIG. 19A is an embodiment of a block diagram of a computing device.

FIG. 19B is an embodiment of a block diagram of a computing device.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Aspects of embodiments of the present invention relate to systems and methods for automating portions of the customer side of interactions between customers and contact centers. Existing systems such as interactive voice response (IVR) or interactive media response (IMR) systems, for example, typically automate portions of the interaction on the contact center side of the interactions. However, much of the customer side of the interaction is still performed manually by the customer. Accordingly, some aspects of embodiments of the present invention relate to providing systems for a customer to automate at least portions of their interactions with contact centers. Some embodiments of the present invention relate to a single system that is configured to interface with multiple different contact centers associated with different organizations such as different commercial enterprises (e.g., different companies, utilities, government entities, and the like).

Some aspects of embodiments of the present invention relate to systems and methods for augmenting an interaction between a customer and an agent of a contact center, such as by providing one or more supplemental communications channels used in conjunction with (e.g., concurrently with) a primary communication channel (e.g., a voice or audio channel). Some aspects of embodiments of the present invention relate to improvements to post-interaction records, such as information about interaction history.

In more detail, some aspects of embodiments of the present invention will be described in the context of a mobile device application configured to facilitate interactions between a plurality of parties, such as between a user (e.g., a customer) and an agent in a contact center environment. In one embodiment of the present invention, the application may be present on a mobile device, such as a smartphone or tablet computer. In various embodiments of the present invention, aspects of methods of the invention may be performed by the application on the mobile device, a server of a cloud computing system, and/or combinations thereof. Different stages of an interaction are described below and how embodiments of the present invention facilitate these stages, including a pre-call stage, a during-call stage, and a post-call stage.

Referring to the example of a contact center environment, during the pre-call stage the user prepares for a live interaction with the contact center agent. Based on a user's input into a user interface (UI) of the application, the intent of the user may be automatically inferred from the input. In some embodiments, recommendations or suggestions based on the inferred user intent are provided to the user through the application UI. Based on the inferred user intent, the application may prompt the user to provide information that will be required for the live conversation, such as user authentication information (e.g., name, account number, and answers to security questions), to name a non-limiting example. Some information may be automatically loaded from a user profile. The application may automatically navigate an IVR on behalf of the user based on the inferred intent of the user and using at least some of the information provided to the application. In some embodiments, some of the information is automatically provided to the contact center agent for review, and, in some embodiments, the information is provided to the agent before the user is connected through a real-time interaction.

In some embodiments, crowd sourced advice is being provided to the user, based on observed successful statements. Multiple communication channels may be offered to the user along with options for callbacks. Callbacks may be automatically suggested by the application based on free time within the user's calendar, which is referenced by the application. A ‘quick actions’ menu may also be presented to the user to provide easy access to common requests.

In some embodiments, an automated assistant (or “customer experience agent”) acts on behalf of the user (or customer) based on the information provided during the pre-call stage. For example, the navigation of the IVR and initial communication of information to the contact center agent may be automatically performed by the automated assistant. In some circumstances, the automated assistant completes the transaction requested by the user (as may be indicated by the inferred intent of the user) without any involvement from the user. In other circumstances, the user completes the transaction by interacting directly with the agent of the contact center after the automated assistant has provided the contact center agent with the information provided through the user interface.

In an embodiment of the during-call stage, the user is connected with a live agent through the application. The application may provide the user with supplemental information while talking with the agent during the interaction. This supplemental information may include, but is not limited to, call meta-data, content sharing and annotations (also available for the agent to share information with the user), camera sharing and augmented reality (AR) for technical support, and text chat. The live interaction with the agent may generally be a voice call, however, it is within the scope of the embodiments for a video call to be contemplated or other forms of voice interaction. Once the live interaction has concluded, the user is able to view the interaction history in the post-call stage along with other relevant data.

Contact Center Overview

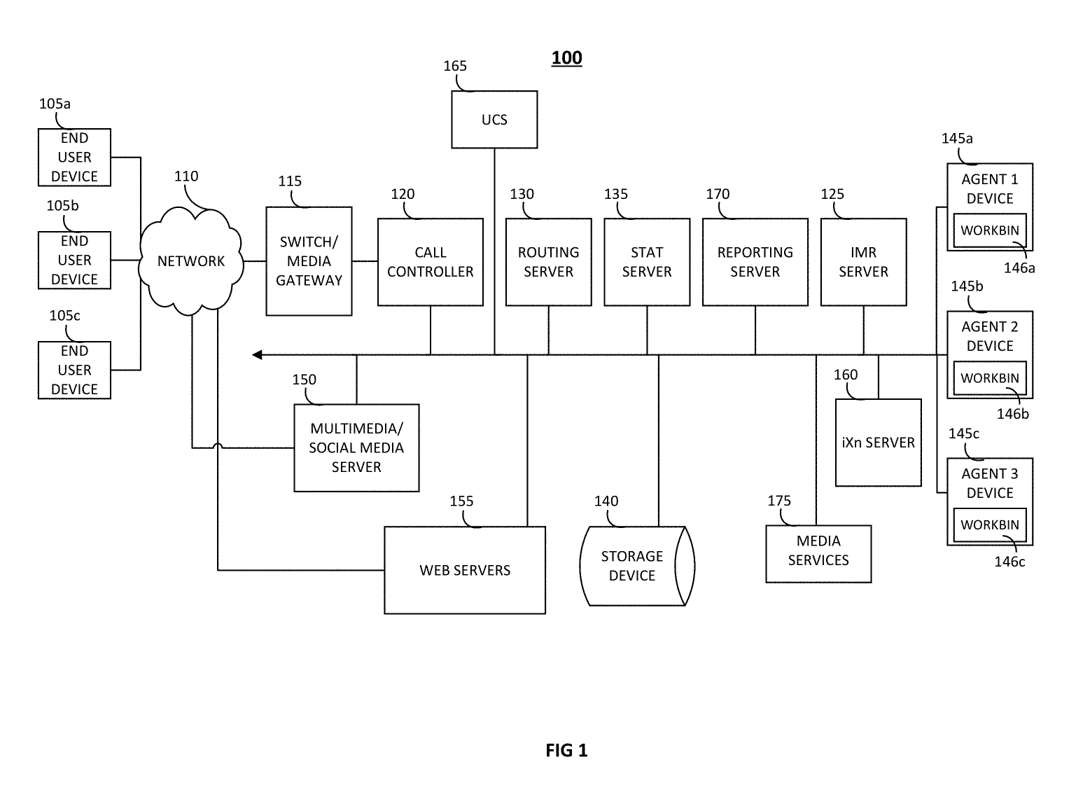

FIG. 1 is an embodiment of a schematic block diagram illustrating a system for supporting a contact center in providing contact center services, indicated generally at 100. The contact center may be an in-house facility to a business or enterprise for serving the enterprise in performing the functions of sales and service relative to the products and services available through the enterprise. In another aspect, the contact center may be operated by a third-party service provider. In an embodiment, the contact center may operate as a hybrid system in which some components of the contact center system are hosted at the contact center premises and other components are hosted remotely (e.g., in a cloud-based environment). The contact center may be deployed in equipment dedicated to the enterprise or third-party service provider, and/or deployed in a remote computing environment such as, for example, a private or public cloud environment with infrastructure for supporting multiple contact centers for multiple enterprises. The various components of the contact center system 100 may also be distributed across various geographic locations and computing environments and not necessarily contained in a single location, computing environment, or even computing device.

Components of the communication infrastructure indicated generally at 100 may include, but not be limited to: a plurality of end user devices 105a, 105b, 105c; a communications network 110; a switch/media gateway 115; a call controller 120; an IMR server 125; a routing server 130; a stat server 135; a storage device 140; a plurality of agent devices 145a, 145b, 145c comprising workbins 146a, 146b 146c; a multimedia/social media server 150; web servers 155; an iXn server 160; a UCS 165; a reporting server 170; and media services 175.

In an embodiment, the contact center system 100 manages resources (e.g. personnel, computers, and telecommunication equipment) to enable delivery of services via telephone or other communication mechanisms. Such services may vary depending on the type of contact center, and may range from customer service to help desk, emergency response, telemarketing, order taking, etc.

Customers, potential customers, or other end users (collectively referred to as customers or end users) desiring to receive services from the contact center may initiate inbound communications (e.g., telephony calls, emails, chats, video chats, social media posts, etc.) to the contact center via their end user devices 105a-105c (collectively referenced as 105). Each of the end user devices 105 may be a communication device conventional in the art, such as, for example, a telephone, wireless phone, smart phone, personal computer, electronic tablet, etc., to name some non-limiting examples. Users operating the end user devices 105 may initiate, manage, and respond to telephone calls, emails, chats, text messaging, web-browsing sessions, and other multi-media transactions. While three end user devices 105 are illustrated in the system 100 (FIG. 1) for simplicity, it is within the scope of the embodiments for any number may be present.

Inbound and outbound communications from and to the end user devices 105 may traverse a telephone, cellular, and/or data communication network 110 depending on the type of device that is being used. For example, the communications network 110 may include a private or public switched telephone network (PSTN), local area network (LAN), private wide area network (WAN), and/or public WAN such as, for example, the Internet. The communications network 110 may also include a wireless carrier network including a code division multiple access (CDMA) network, global system for mobile communications (GSM) network, or any wireless network/technology conventional in the art, including but to limited to 3G, 4G, LTE, etc.

In an embodiment, the contact center system includes a switch/media gateway 115 coupled to the communications network 110 for receiving and transmitting telephony calls between end users and the contact center. The switch/media gateway 115 may include a telephony switch or communication switch configured to function as a central switch for agent level routing within the contact center. The switch may be a hardware switching system or a soft switch implemented via software. For example, the switch 115 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, an agent telephony or communication device. In this example, the switch/media gateway establishes a voice path/connection (not shown) between the calling customer and the agent telephony device, by establishing, for example, a connection between the customer's telephony device and the agent telephony device.

In an embodiment, the switch is coupled to a call controller 120 which may, for example, serve as an adapter or interface between the switch and the remainder of the routing, monitoring, and other communication-handling components of the contact center.

The call controller 120 may be configured to process PSTN calls, VoIP calls, and the like. For example, the call controller 120 may be configured with computer-telephony integration (CTI) software for interfacing with the switch/media gateway and contact center equipment. In one embodiment, the call controller 120 may include a session initiation protocol (SIP) server for processing SIP calls.

According to some exemplary embodiments, the call controller 120 may, for example, extract data about the customer interaction such as the caller's telephone number (often known as the automatic number identification (ANI) number), or the customer's internet protocol (IP) address, or email address, and communicate with other contact center components in processing the interaction.

In an embodiment, the system further includes an IMR server 125, which may also be referred to as a self-help system, virtual assistant, or the like. The IMR server 125 may be similar to an IVR server, except that the IMR server 125 is not restricted to voice and may cover a variety of media channels, including voice. Taking voice as an example, however, the IMR server 125 may be configured with an IMR script for querying customers on their needs. For example, a contact center for a bank may tell customers, via the IMR script, to “press 1” if they wish to get an account balance. If this is the case, through continued interaction with the IMR server 125, customers may complete service without needing to speak with an agent. The IMR server 125 may also ask an open-ended question such as, for example, “How can I help you?” and the customer may speak or otherwise enter a reason for contacting the contact center. The customer's response may then be used by a routing server 130 to route the call or communication to an appropriate contact center resource.

If the communication is to be routed to an agent, the call controller 120 interacts with the routing server (also referred to as an orchestration server) 130 to find an appropriate agent for processing the interaction. The selection of an appropriate agent for routing an inbound interaction may be based, for example, on a routing strategy employed by the routing server 130, and further based on information about agent availability, skills, and other routing parameters provided, for example, by a statistics server 135.

In some embodiments, the routing server 130 may query a customer database, which stores information about existing clients, such as contact information, service level agreement requirements, nature of previous customer contacts and actions taken by contact center to resolve any customer issues, etc. The database may be, for example, Cassandra or any NoSQL database, and may be stored in a mass storage device 140. The database may also be a SQL database and may be managed by any database management system such as, for example, Oracle, IBM DB2, Microsoft SQL server, Microsoft Access, PostgreSQL, MySQL, FoxPro, and SQLite. The routing server 130 may query the customer information from the customer database via an ANI or any other information collected by the IMR server 125.

Once an appropriate agent is identified as being available to handle a communication, a connection may be made between the customer and an agent device 145a-145c (collectively referenced as 145) of the identified agent. Collected information about the customer and/or the customer's historical information may also be provided to the agent device for aiding the agent in better servicing the communication. In this regard, each agent device 145 may include a telephone adapted for regular telephone calls, VoIP calls, etc. The agent device 145 may also include a computer for communicating with one or more servers of the contact center and performing data processing associated with contact center operations, and for interfacing with customers via voice and other multimedia communication mechanisms.

The contact center system may also include a multimedia/social media server 150 for engaging in media interactions other than voice interactions with the end user devices 105 and/or web servers 155. The media interactions may be related, for example, to email, vmail (voice mail through email), chat, video, text-messaging, web, social media, co-browsing, etc. In this regard, the multimedia/social media server 150 may take the form of any IP router conventional in the art with specialized hardware and software for receiving, processing, and forwarding multi-media events.

The web servers 155 may include, for example, social interaction site hosts for a variety of known social interaction sites to which an end user may subscribe, such as, for example, Facebook, Twitter, Instagram, etc. In this regard, although in the embodiment of FIG. 1 the web servers 155 are depicted as being part of the contact center system 100, the web servers 155 may also be provided by third parties and/or maintained outside of the contact center premises. The web servers may also provide web pages for the enterprise that is being supported by the contact center. End users may browse the web pages and get information about the enterprise's products and services. The web pages may also provide a mechanism for contacting the contact center, via, for example, web chat, voice call, email, WebRTC, etc.

According to one exemplary embodiment of the invention, in addition to real-time interactions, deferrable (also referred to as back-office or offline) interactions/activities may also be routed to the contact center agents. Such deferrable activities may include, for example, responding to emails, responding to letters, attending training seminars, or any other activity that does not entail real time communication with a customer. In this regard, an interaction (iXn) server 160 interacts with the routing server 130 for selecting an appropriate agent to handle the activity. Once assigned to an agent, an activity may be pushed to the agent, or may appear in the agent's workbin 146a-146c (collectively referenced as 146) as a task to be completed by the agent. The agent's workbin may be implemented via any data structure conventional in the art, such as, for example, a linked list, array, and/or the like. The workbin 146 may be maintained, for example, in buffer memory of each agent device 145.

According to one exemplary embodiment of the invention, the mass storage device(s) 140 may store one or more databases relating to agent data (e.g. agent profiles, schedules, etc.), customer data (e.g. customer profiles), interaction data (e.g. details of each interaction with a customer, including reason for the interaction, disposition data, time on hold, handle time, etc.), and the like. According to one embodiment, some of the data (e.g. customer profile data) may be maintained in a customer relations management (CRM) database hosted in the mass storage device 140 or elsewhere. The mass storage device may take form of a hard disk or disk array as is conventional in the art.

According to some embodiments, the contact center system may include a universal contact server (UCS) 165, configured to retrieve information stored in the CRM database and direct information to be stored in the CRM database. The UCS 165 may also be configured to facilitate maintaining a history of customers' preferences and interaction history, and to capture and store data regarding comments from agents, customer communication history, and the like.

The contact center system 100 may also include a reporting server 170 configured to generate reports from data aggregated by the statistics server 135. Such reports may include near real-time reports or historical reports concerning the state of resources, such as, for example, average waiting time, abandonment rate, agent occupancy, and the like. The reports may be generated automatically or in response to specific requests from a requestor (e.g. agent/administrator, contact center application, etc).

The various servers of FIG. 1 may each include one or more processors executing computer program instructions and interacting with other system components for performing the various functionalities described herein. The computer program instructions are stored in a memory implemented using a standard memory device, such as, for example, a random-access memory (RAM). The computer program instructions may also be stored in other non-transitory computer readable media such as, for example, a CD-ROM, flash drive, or the like. Also, although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

In the various embodiments, the terms “interaction” and “communication” are used interchangeably, and generally refer to any real-time and non-real time interaction that uses any communication channel including, without limitation telephony calls (PSTN or VoIP calls), emails, vmails (voice mail through email), video, chat, screen-sharing, text messages, social media messages, WebRTC calls, etc.

As noted above, the contact center may operate as a hybrid system in which some or all components are hosted remotely, such as in a cloud-based environment. For the sake of convenience, aspects of embodiments of the present invention will be described below with respect to providing remotely hosted media services 175 in a cloud-based environment. In these examples, the media services 175 may provide audio and/or video services to support contact center features such as prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, and keyword spotting, to name some non-limiting examples.

Customer Experience Automation System Architecture

As noted above, aspects of embodiments of the present invention include systems and methods for automating and augmenting interactions in various stages, including pre-call, during-call, and post-call (or pre-interaction, during-interaction, and post-interaction) stages.

Pre-Call Customer Experience Automation System

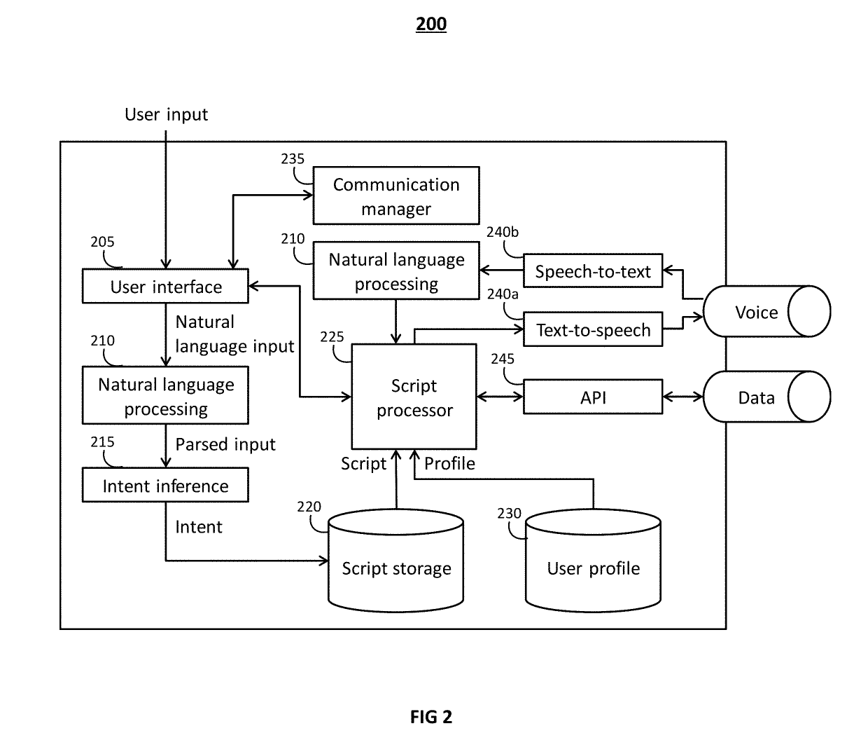

FIG. 2 is an embodiment of a configuration of a block diagram of a pre-call customer experience automation system, indicated generally at 200. In various embodiments of the present invention, the pre-call customer experience automation system may be implemented in an application running on a mobile device of a customer (e.g., an end user device 105), one or more cloud computing devices (e.g., one or more computer servers connected to the end user device 105 over a network 110), or combinations thereof (e.g., some modules of the system are implemented in the application while other modules are implemented in the one or more cloud computing devices). For the sake of convenience, embodiments of the present invention will be described in the context of embodiments where the pre-call customer experience automation system is implemented in an application running on the end user device 105. However, it is to be understood that embodiments of the present invention are not limited thereto and may involve some components being implemented in a cloud computing device. In some embodiments of the present invention, the customer experience automation system 200 is implemented in dedicated hardware that is customized by being particularly programmed to perform the operations described herein. In some embodiments, components of the customer experience automation system 200 are implemented in dedicated hardware (e.g., a field programmable gate array or FPGA that has been configured using a bitfile to specify an arrangement of the gates to perform a particular task, or an application specific integrated circuit or ASIC that is designed to perform a particular task).

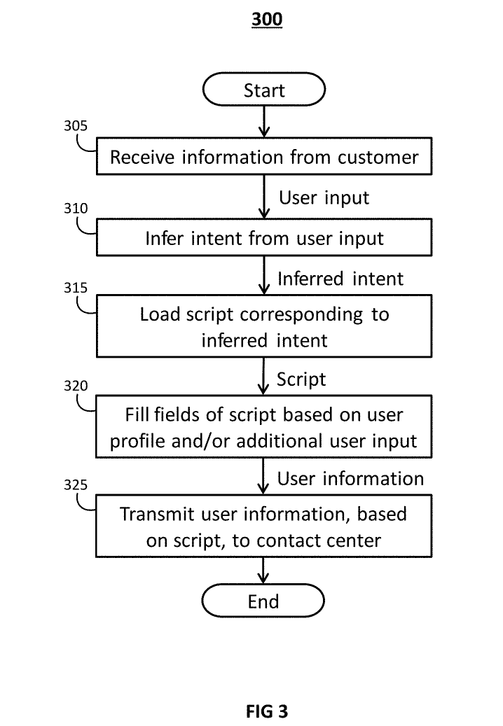

FIG. 3 is an embodiment of a flowchart of a method for automating a pre-call stage of an interaction, indicated generally at 300. According to some embodiments, during the pre-call stage, in operation 305, the pre-call customer experience automation system (or “application”) 200 (referring to FIG. 2) automatically collects information from a user through a user interface 205, where the collection of information does not require the involvement of a live agent. The user input is provided in the form of free speech or text (e.g., unstructured, natural language input). This information may be used by the application 200 for routing the user to a particular agent in the contact center, as well as pulling information from other sources to be provided to the agent (e.g., to provide the agent with as much information as possible about the customer's issue).

In operation 310 of FIG. 3, the application parses the natural language user input using a natural language processing module 210 from the system 200 (FIG. 2) and infers the customer's intent using an intent inference module 215 in order to classify said intent. Where the user input is provided as speech, the speech is transcribed into text by a speech-to-text system (such as a large vocabulary continuous speech recognition or LVCSR system) as part of the parsing by the natural language processing module 210.

In an embodiment of operation 310 (FIG. 3), the intent inference module 215 (FIG. 2) of the application 200 automatically infers the user's intent from the text of the user input using artificial intelligence or machine learning techniques. These artificial intelligence techniques may include, for example, identifying one or more keywords from the user input and searching a database of potential intents (e.g., call reasons) corresponding to the given keywords. The database of potential intents and the keywords corresponding to the intents may be automatically mined from a collection of historical interaction recordings, in which a customer may provide a statement of the issue (e.g., at the beginning of the interaction, in response to an agent question such as “how may I help you today?”) and in which the intent is explicitly encoded by the customer service agent.

Referring to FIG. 3, after the application has inferred the reason for the inquiry, in operation 315, the application loads a “script” associated with the given intent, where the script may be stored in a script storage module 220 (FIG. 2). In some embodiments, a script processor module 225 reads the script and provides recommendations to the user through the user interface 205 (e.g., a display device and/or a text-to-speech module associated with the user interface 205). Examples of recommendations might include, but not be limited to: recommending the user to contact the provider, directing the user to relevant self-help resources (e.g., links to relevant customer service or customer support web sites) based on the inferred needs, etc.

In some embodiments, crowd sourced advice based on observed successful interactions is provided to the user. Additionally, some users may choose to share their prior interactions to assist other users. In another embodiment, an automatic recommendation generator analyzes recorded interactions to generate recommendations. For example, the recommendation generator may group together recorded interactions that have the same inferred intent. These interactions are further divided into interactions in which the user successfully resolved their issues and interactions in which the user failed to resolve their issues. The successful interactions and the unsuccessful interactions are then analyzed to determine shared characteristics. For example, some issues may show higher rates of successful resolution when conducted over chat message than over voice communications. Other issues may show higher rates of successful resolution when the user mentions the possibility of switching to a competitor's service. Still other issues may show higher rates of successful resolution when performed using a self-help system (e.g., through a web site) than through a call to a contact center. Accordingly, aspects of embodiments of the present invention allow a user to receive recommendations of different ways of attempting to resolve their issues with the organization.

In some embodiments of the present invention, a user may choose to contact the provider. Accordingly, some aspects of embodiments of the present invention relate to automatically navigating an IVR system of a contact center on behalf of a user using, for example, the loaded script. In some embodiments of the present invention, the script includes a set of fields (or parameters) of data that are expected to be required by the contact center in order to resolve the issue specified by the user's intent. In some embodiments of the present invention, some of the fields of data are automatically loaded from a stored user profile 230. These stored fields may include, for example, the user's full name, address, customer account numbers, authentication information (e.g., answers to security questions) and the like. In case of any ambiguity regarding the parameters or missing information, the script processor 225 of the application 200 will allow the user to manually provide relevant value(s) for the interaction.

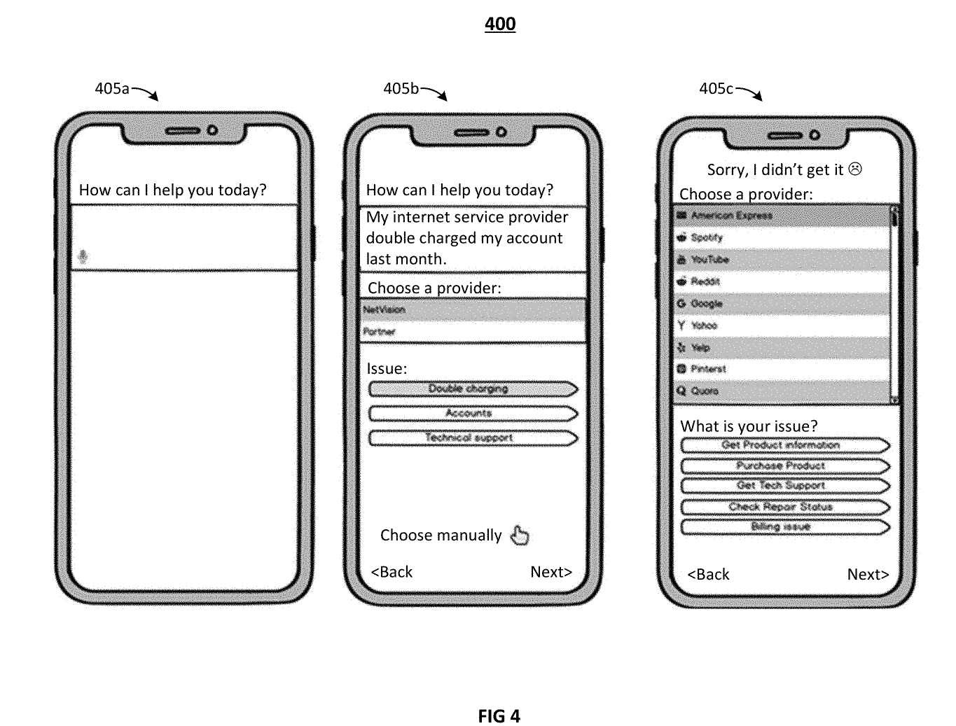

FIG. 4A is a diagram illustrating embodiments of a landing screen, indicated generally at 400. FIG. 4A presents an example of automatic intent classification through the application. In the embodiment shown in FIG. 4A, the application displays to the user “How can I help you today?” 405a in the user interface 205 when the user launches the application or requests assistance in the application 200 (FIG. 2) on a user device 105. The user then expresses their intent to the application. Referring to 405b in FIG. 4A, the user has replied: “My internet service provider double charged me last month.” A user's reply may be given in any number of ways, such as through free speech or text (e.g., natural language input). Where free speech is used, the speech is transcribed into text within the application using speech recognition software (e.g., LVCSR), where the transcription may be performed locally on the end user device 105 or the speech may be transmitted over a network for conversion to text by a cloud-based server. From this text, the pre-call customer experience automation application 200 understands that the user has a billing issue and that the relevant provider (e.g., commercial enterprise or other organization) for this issue is “NetVision” based on the user's information stored in the user profile in the application. Should there be any ambiguity (e.g., the user has uses more than one internet provider), the application may offer the user options. For example, as shown in 405b, the application has identified automatically the relevant department and has identified NetVision and Partner as the potential entities the user has issue with. In another embodiment, manual selection may be used for identification of the provider, as shown at 405c. A selection of the user's service providers and issues may be presented to the user in the UI 205 when the application 200 has failed to understand the user intent from the user's input. After the user has selected a provider (e.g., organization) or the application has inferred which provider (e.g., organization) the user wishes to interact with, the application will offer IVR options specific to the provider, as specified by the script.

After the user's intent has been determined, the script processor 225 (FIG. 2) of the application 200 extracts the parameters relevant for the interaction from the user profile. This may be based on the user's previous interactions, predefined values set by the user, and the like. As illustrated in the example at 405b, NetVision has been inferred from “my internet service provider” within the user's statement: “My internet service provider double charged my account last month.” The inferred data, here “my internet service provider” may be used by the application to navigate the IVR and to prepare automatic actions for the user, which is described in greater detail below.

In an embodiment, after a user has provided their intent to the application, in operation 315 (FIG. 3), the application 200 may provide guidance to the user based on the recommendations and actions of other users with similar intent. For example, “The best promotions are at the end of the month” may be returned to the user through the UI using a functionality for managing communications. Systems and methods for generating these recommendations will be described in more detail below.

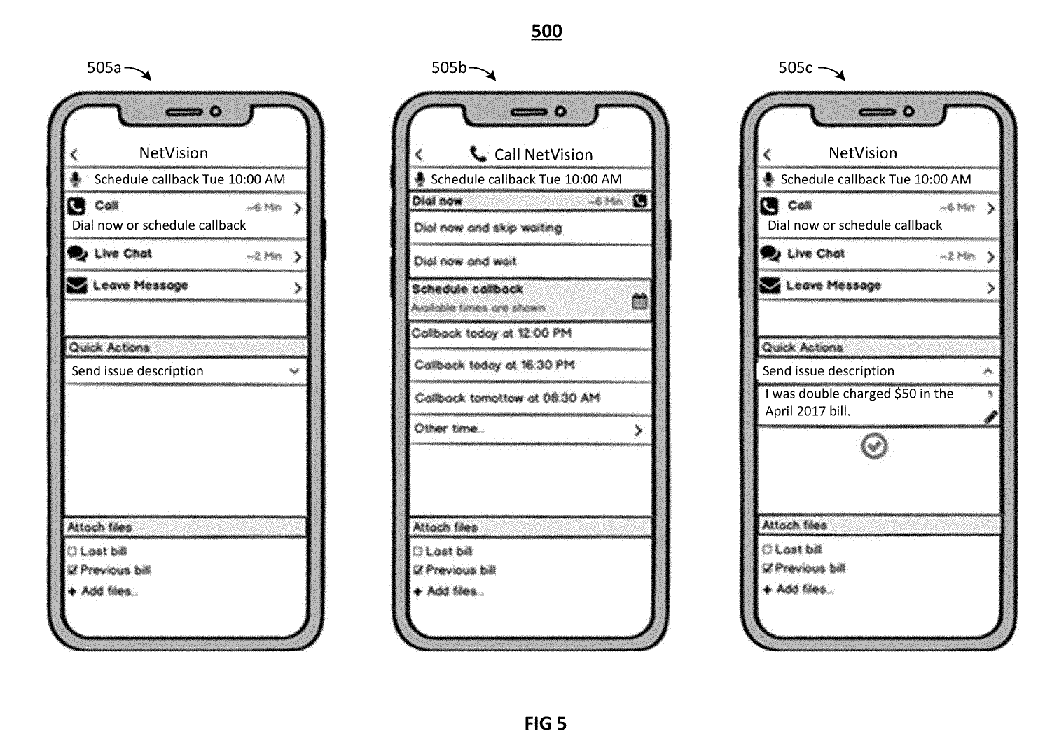

FIG. 5 is an embodiment of diagrams illustrating interaction menus for the application, indicated generally at 500. Within the application 200, the user is able to contact the providers they conduct business with using multiple channels for communication, such as, call (e.g., voice and/or video), chat, and e-mail, to name a few non-limiting examples. Referring to the example shown at 505a, the communication examples provided in the menu include calling, chatting, and leaving a message. Estimated wait times for interactions with a live agent (e.g., call or chat) may also be shown to the user. For example, if the user chooses to call and speak with a live agent, the user may be offered several options. These options might include to wait (e.g., “dial now and wait”), select a callback (e.g., “dial now and skip waiting”), or schedule a call for a given time (e.g., “schedule a callback”) 505b. In an embodiment, if the user selects to schedule a call for a given time by opting for “schedule a callback,” for example, the application 200 may access the user's calendar (stored/accessible on the same end user device 105) and offer suggestions for free times in the user's calendar. In the example shown in FIG. 5, the application 200 has determined the user is free today at 12:00, 16:30, and tomorrow at 08:30. These times may be automatically presented to the user. The user may also choose to schedule a call at another time and input this into the UI 205. For example, the user may provide “Schedule callback Tue 10:00 AM” to the application.

Some aspects of embodiments of the present invention relate to enabling callback scheduling even when contact centers do not directly support such a feature. For example, assuming that the user has scheduled a callback for 10:00, the system may automatically determine the approximate wait time during the time periods leading up to 10:00. This might be based on historical data captured from other users contacting this particular organization or it may be based on wait time data published by the organization.

In an embodiment, the pre-call customer experience automation system 200 automatically connects to the contact center at a time prior to the scheduled call back time, based on the expected wait time, and supplies the set of information provided to the pre-call customer experience automation system 200 in accordance with the script in order to be placed on hold by the contact center. For example, the pre-call customer experience automation system 200 may automatically determine that the expected wait time at 09:15 is 45 minutes, and therefore initiates communication with the contact center at 09:15 in order have an agent available to speak to the user at around 10:00. When the pre-call customer experience automation system 200 is connected to a live contact center agent (e.g., by detecting a ringing on the contact center end of the communication channel or by detecting a voice saying “hello”), the customer experience automation system 200 automatically notifies the user (e.g., by ringing at the end user device 105) and connects the user to the live contact center agent.

Some embodiments also relate to providing the user with automatically generated “quick actions” based on the supplied user intent. In some circumstances, the “quick actions” require no further input from the user. For example, the application may suggest sending an automatically generated text or email message to the provider directly from the main menu screen 505c, where the message describes the user's issue. The message may be generated automatically by the script processor based on a message template provided by the script, where portions of the template that contain user-specific and incident-specific data are automatically filled in based on data collected about the user (e.g., from the user profile) and that the user has supplied (e.g., as part of the initial user input). Referring to the above example where the user input states that the user was double charged, the script processor 225 (FIG. 2) can reference previous billing statements, which may be stored as part of the user profile 230, to look for historical charges. The application 200 infers from these previous billing statements that the user is usually charged $50 per month but in the last month, the user was charged $100. As such, the application automatically generates a message which may contain the information about the user's typical bills and the problem with the current bill. The user can control the application 200 to send the automatically generated message directly to the provider. In some embodiments, the script provides multiple templates, and the user may select from among the templates and/or edit a message prior to sending, in order to match the user's personality or preferred tone of voice.

In some embodiments of the present invention, the application 200 provides functionality to allow a user to supply additional material that will be relevant to the interaction within the application. The functionality may be provided through the UI 205 and may be performed using, for example, the “Share” functionality of mobile operating systems such as Android® and iOS®. Referring to 505a in FIG. 5, for example, the user may be presented with a selection of descriptions of the files which will be uploaded (‘Last bill’, ‘Previous bill’) and/or a link to directly upload files without a prefilled description of the files. Other examples of descriptions/information include, for example, photographs of broken or failed products, screenshots of error messages, copies of documents, proofs of purchase, etc. In some embodiments, these documents are provided along with the automatically generated “quick actions” message. The message may serve to prompt the user, by the application 200, to take a photo of the broken part, for inclusion in the material.

Some aspects of embodiments of the present invention relate to pre-live call preparation. For example, the user may request that the agent study the material provided by the user before the live call happens.

Some aspects of embodiments of the present invention relate to the automatic authentication of the user with the provider. For example, in some embodiments of the present invention, the user profile 230 (FIG. 2) includes authentication information that would typically be requested of users accessing customer support systems such as usernames, account identifying information, personal identification information (e.g., a social security number), and/or answers to security questions. As additional examples, the application 200 may have access to text messages and/or email messages sent to the user's account on the end user device 105 in order to access one-time passwords sent to the user, and/or may have access to a one-time password (OTP) generator stored locally on the end user device 105. Accordingly, embodiments of the present invention may be capable of automatically authenticating the user with the contact center prior to an interaction.

In some embodiments of the present invention, a communication manager 235 monitors conditions for a user based on specified intents and automatically generates notifications to be presented to the user through the user interface 205. In an embodiment, based one or more of: the previous activity of the user, the user's billing statements (e.g., stored in the user profile 230), and communications from different providers (e.g., emails), the communication manager 235 automatically generates notifications which might be of interest to the user. Examples of a notification generated by the communication manager include: a reminder about the upcoming expiration of a deal, an offer of a new deal, actions for the user, and the like. For example, in one embodiment, the notification may offer quick actions that can be performed directly from the notification screen, such as: get a specific deal, call the provider about a specific deal, search for more deals, cancel a service, etc. In some aspects of embodiments of the present invention, the communication manager 235 customizes notifications to the user based on the user's previous deals, billing statements, crowd-sourced information about how similar users reacted to deals, personal preferences, and the like. In some embodiments of the present invention, the communication manager 235 provides functionality through the user interface 205 for the user to search for more deals based on their needs. Should the user select this option, the application may present some relevant deals that are identified from a database of deals.

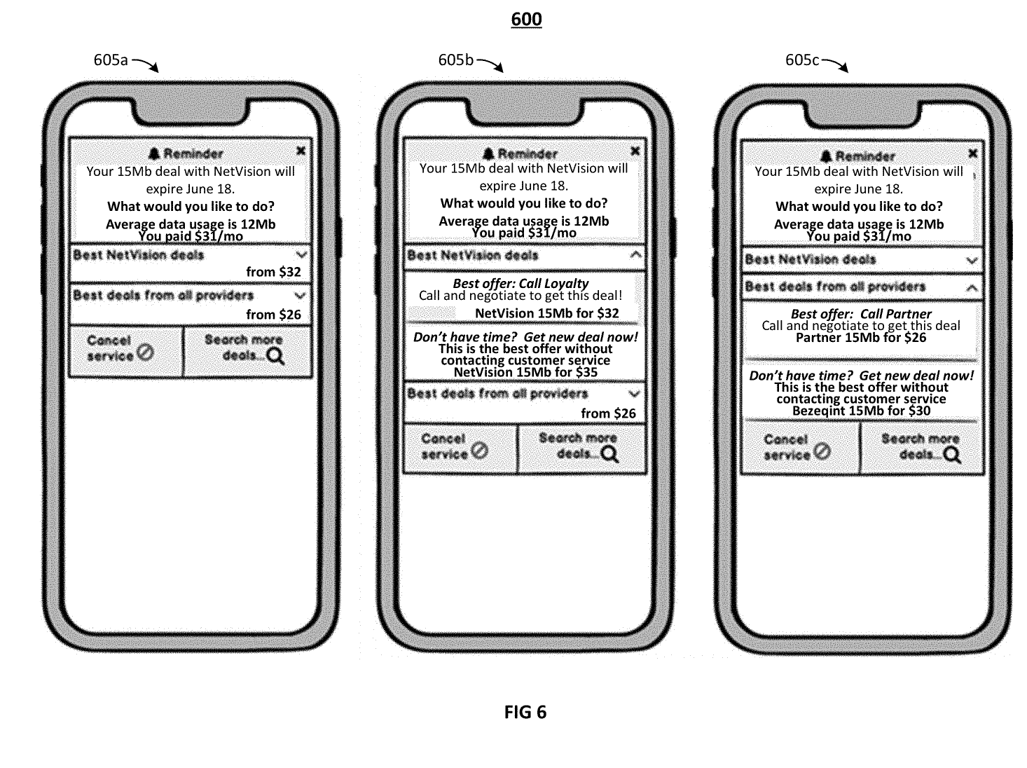

FIG. 6 is a diagram illustrating an embodiment of a notification, indicated generally at 600. For example, 605a shows an example for an ‘end of deal’ notification. The user is informed about the ending of their internet package deal with their current internet service provider (ISP). The user may be presented with the best deals offered by their current ISP (605b) and the best deals offered by other ISPs (605c). In the example shown in FIG. 6, the application 200 offers specific deals without requiring communication with the provider, such as a call-in to the relevant customer service department. Pricing may also be shown along with data comparisons relevant to the user. For example, promotional offers may be compared to the average usage of the user (e.g., based on the user profile) and current pricing of their plan. Other suggested options that are specific to the user intent in the notification may also be presented, as shown in FIG. 6, such as a “cancel service” option and an option to “search more deals.” Should the user select the “cancel service” option, the application may send a cancellation request to the provider automatically. The application may also search for more deals which fit the user's needs and present these whether the user has selected to cancel their service or just search for additional deals. In some embodiments, these may also be presented to the user as in FIG. 6.

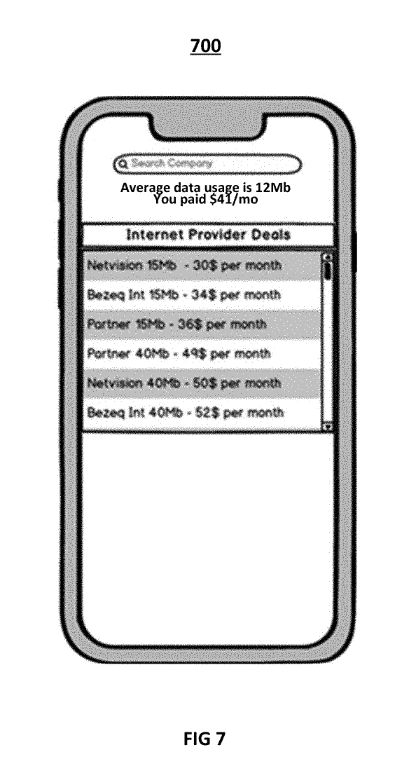

FIG. 7 is a diagram illustrating an embodiment of examples of searched deals, indicated generally at 700. In this example, a plurality of internet providers are shown along with data limits and the cost of each.

Customer Experience Assistant

Some embodiments relate to the use of an automated assistant or “customer agent” configured to automatically interact with a contact center agent on behalf of the customer. As noted above, some aspects of embodiments of the present invention relate to using the pre-call customer experience automation system 200 to automatically navigate an IVR menu system including, for example, authenticating a user by providing authentication information (e.g., entering a customer number through dual-tone multi-frequency or DTMF or “touch tone” signaling or through text to speech synthesis) and selecting menu options (e.g., using DTMF signaling or through text to speech synthesis) to reach the proper department associated with the inferred intent from the customer's user input.

In an embodiment, the pre-call customer experience automation system 200 further conducts an interaction with the contact center on behalf of the user. This allows the user to provide information to the customer experience automation system 200 on their own time, without having to wait on hold with a contact center and without having to wait on line for a contact center agent to process their requests.

For example, the script loaded from script storage 220 (FIG. 2) further includes a defined dialogue (e.g., a dialogue tree or interaction script). The defined dialogue might include templates of statements for the customer experience automation system 200 to make to a live agent through the use of a chat bot system. The templates may include prewritten text and fields or blanks to be filled in with information specific to the user's particular circumstances. For example, data from the user profile 230 and/or data provided by the user through the user interface 205 might be used. The templates may also include a statement of the reason for the call (e.g., “I am calling on behalf of your customer, Mr. Thomas Anderson, regarding what appears to be double billing.”), descriptions of details of the problem (e.g., “In the previous three months, his bill was approximately fifty dollars. However, his most recent bill was for one hundred dollars.”), and the like. In operation 320 of FIG. 3, the script processor 225 (FIG. 2) prompts the user to supply any missing information (e.g., information that is not available from the user profile 230) to fill in blanks in the template through the user interface 205 prior to initiating a communication with the contact center. In some embodiments, the script processor 225 also requests that the user confirm the accuracy of all of the information that the customer experience automation system 200 will provide to the contact center.

In an embodiment, a speech synthesizer or text-to-speech module 240a may be used to generate speech to be transmitted to the contact center agent over a voice communication channel in operation 325 (FIG. 3). In another embodiment, speech received from the agent may be converted to text by a speech-to-text converter 240b (FIG. 2), and the contact center agent's response may be processed by the chat bot system to generate an appropriate response in the dialogue tree. If the agent's response cannot be processed by the dialogue tree, the customer experience automation system 200 may ask the agent to rephrase the response, or the customer experience automation system 200 may connect the user with the interaction to allow the user to complete the transaction. In another embodiment, the speech synthesizer 240a may be used by the script processor 225 executing the interaction script, to interact with the contact center agent, including providing the information specified by the script, answering questions from the agent (based on information available in the user profile 230), and requesting that the agent review the documents. During or after conducting the interaction with the contact center agent in accordance with the interaction script, the contact center agent may indicate his or her readiness to speak to the user (the customer). For the agent, readiness might occur after reviewing all of the media documents provided to the agent and reviewing the user's records. In an embodiment, the script processor 225 may detect a phrase spoken by the agent to trigger the connection of the user to the agent via the communication channel (e.g., by ringing the end user device 105 of the user). In the above example, in which the name of the user is Mr. Thomas Anderson, phrases might comprise: “I am ready to speak to Mr. Anderson now,” “please connect me to Tom now,” or “I've reviewed the file and am ready to discuss.” The phrase may be converted to text by the speech-to-text converter 240b and the natural language processing module 210 may determine the meaning of the converted text (e.g., identifying keywords and/or matching the phrase to a particular cluster of phrases corresponding to a particular concept).

The script loaded from the script storage may be specific to a particular provider (or a particular organization, such as the NetVision ISP example described above) and, in some embodiments, may be further tailored to resolving a particular issue. Scripts may be organized in a number of ways. In an embodiment, the scripts are organized in a hierarchical fashion, such as where all scripts pertaining to a particular organization are derived from a common “parent” script that defines common features. An example of common features might be common templates for authentication steps (e.g., account numbers and verification codes), where “child” scripts include templates for the different types of issues to be resolved (e.g., double billing; requests for reductions in price, service pausing, service plan modification, service cancellation, and the like). In some embodiments, rather than a hierarchical relationship, the scripts are assembled from common tasks, such as combining “authentication” templates for authenticating with various service providers and “issue” templates for resolving common issues that may be associated with multiple providers.

In some embodiments of the present invention, the templates and sequences of statements (generated from the templates) made during a request for resolution of a particular issue are automatically mined from a collection of historical interactions with one or more service providers. Systems and methods for automatically mining effective sequences of statements and comments, as described from the contact center agent side, are described in U.S. patent application Ser. No. 14/153,049 “COMPUTING SUGGESTED ACTIONS IN CALLER AGENT PHONE CALLS BY USING REAL-TIME SPEECH ANALYTICS AND REAL-TIME,” filed in the United States Patent and Trademark Office on Jan. 12, 2014, the entire disclosure of which is incorporated by reference herein. While U.S. patent application Ser. No. 14/153,049 describes determining sequences of statements made by a contact center agent to achieve a successful result (referred to as a “golden sales formula”), the technique can be modified to automatically extract sequences of categories of statements (referred to in U.S. patent application Ser. No. 14/153,049 as “topics” or “events”) made by customers that result in a positive outcome (e.g., resolution of a customer's issue). In more detail, phrases detected in customer speech are sorted into semantic “events” (or “topics”) and sequences of “events” that lead to successful results (e.g., satisfaction of the customer request, as manually indicated by the contact center agent or as determined through semantically analyzing the end of the interaction for phrases such as “thank you for handling this problem”) are treated as good sequences. In various embodiments of the present invention, phrases are selected from the clustered phrases for use in the templates of the script, where customer specific information in the phrases (e.g., addresses, account numbers, and personally identifying information) are replaced with a “token” representing the type of information that is to be filled in by the script processor 225 (e.g., from the user profile 230 and/or provided by the user through the user interface 205, and the like).

In some embodiments of the present invention an application programming interface (API) 245 is used to interact with the provider directly in operation 325 (FIG. 3). The provider may define a protocol for making commonplace requests to their systems. This API may be implemented over a variety of standard protocols such as Simple Object Access Protocol (SOAP) using Extensible Markup Language (XML), a Representational State Transfer (REST) API with messages formatted using XML or JavaScript Object Notation (JSON), and the like. Accordingly, a customer experience automation system 200 according to one embodiment of the present invention automatically generates a formatted message in accordance with an API define by the provider, where the message contains the information specified by the script in appropriate portions of the formatted message.

Accordingly, some aspects of embodiments of the present invention relate to systems and methods for automatically initiating and conducting an interaction with a contact center to resolve an issue on behalf of a user.

Augmenting a Live Interaction with Additional Media

Some aspects of embodiments of the present invention relate to systems and methods for automating and augmenting aspects of an interaction between the user and a live agent of the contact center. In some embodiments of the present invention, the systems for providing automating and augmenting the interaction between the user and the live agent are provided by the customer experience automation system 200 described above. In other embodiments of the present invention, one or more hardware components and software modules of the end user device 105 provide aspects of the functionality for automating and augmenting the interaction. In some embodiments of the present invention, one or more supplemental communication channels (e.g., a data channel) is established in parallel to the primary communication channel (e.g., a voice communication channel or a text communication channel) to transfer the augmenting information between the user and the agent of the contact center.

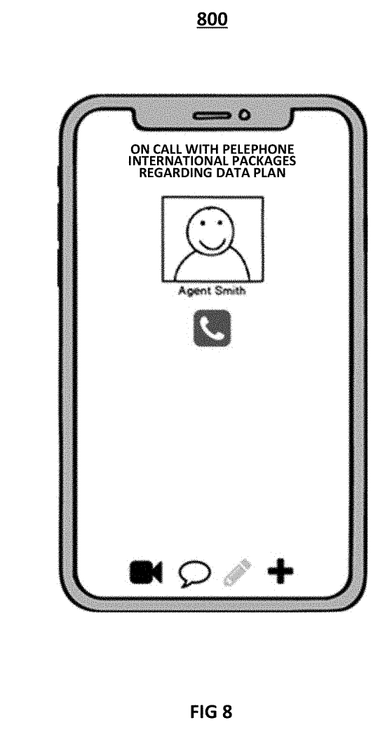

In an embodiment, once the interaction, such as through a phone call, has been initiated with a live agent, meta-data regarding the conversation is displayed to the user in the UI 205 (FIG. 2) throughout the interaction. FIG. 8 is an embodiment of a diagram illustrating a landing screen which may be displayed to the user when an interaction is initiated, indicated generally at 800. Information, such as call metadata, may be presented to the user through the UI 205 on the user's mobile device 105. Examples of such information might include, but not be limited to, the provider, department call reason, agent name, and a photo of the agent. In FIG. 8, a visual of the agent is presented along with the information “On call with Pelephone International Packages Regarding Data Plan.”

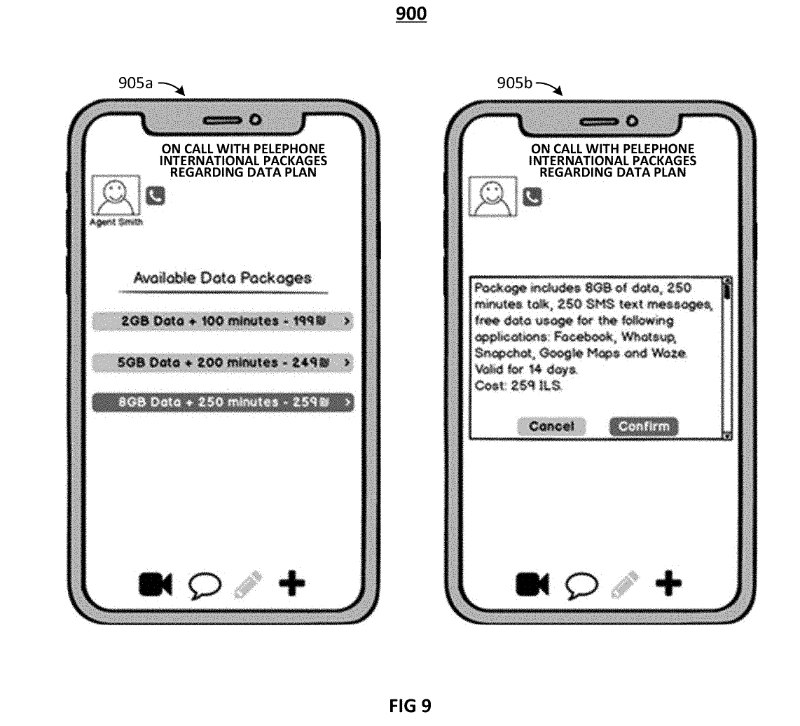

In an embodiment, the agent may provide the user with a visual interface while they are presenting the user with verbal information. FIG. 9 is a diagram illustrating an embodiment of a visual interface, indicated generally at 900. For example, the user may be offered several options. In 905A, the user is shown, through the user interface 205 of the end user device 105, a plurality of available data packages which are offered by their provider. This visual depiction assists the user with being able to see and compare all available options without the need to remember or write them down as the agent speaks. The user can then expand an option for a more detailed explanation of the package 905B while maintaining the verbal interaction with the agent. The user may also be presented with options to confirm selection of the package or to go back to the previous screen and review other options, giving the user the ability to browse information related to the verbal interaction with the agent as the interaction is occurring.

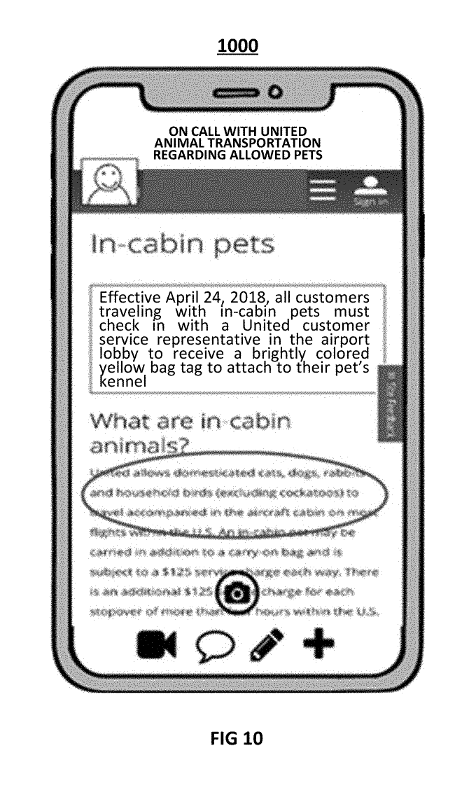

According to some aspects of embodiments of the present invention, both the user and the agent can share relevant content with each other through the application (e.g., the application running on the end user device 105). In one embodiment, the agent may share their screen with the user or push relevant material to the user. The application may also “listen” in on the conversation and automatically push relevant content from a knowledge base to the user. FIG. 10 is a diagram illustrating an embodiment of shared content, indicated generally at 1000. Here, an agent is sharing a document with the user. In this example, the agent is providing the user with information related to in-cabin pets for an airline flight. Specifically, the user might have a question about which animals are allowed in the airplane cabin during flight. According to some embodiments, the agent may also mark important details in the shared information in response to the user's inquiry (e.g., with a circle around the relevant information) and the agent's annotations are automatically shown in real time during the interaction to the user on the user interface 205 of the end user device 105, as shown in 1000.

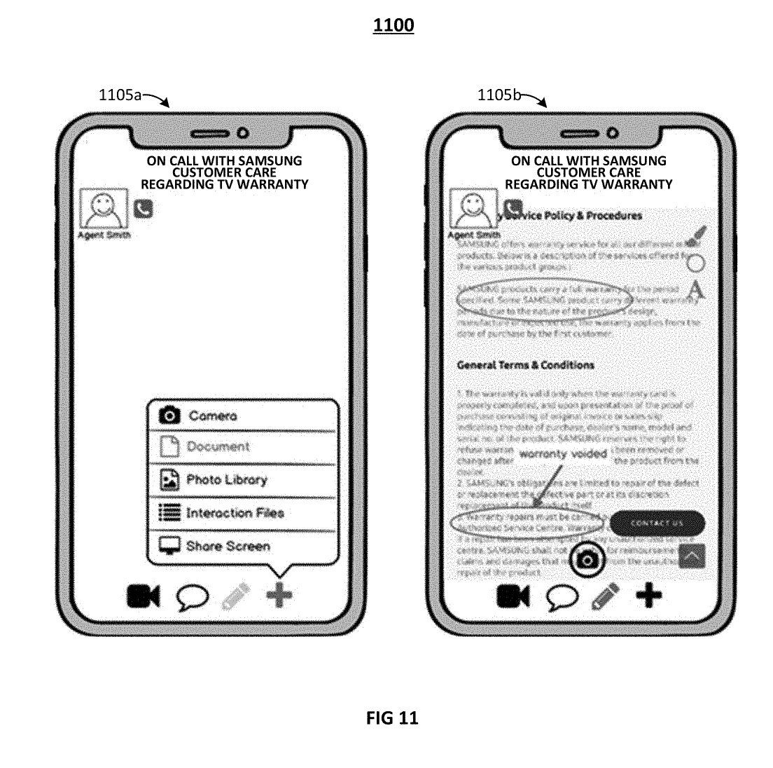

FIG. 11 is a diagram illustrating types of content the user is able to share with the agent through the application, indicated generally at 1100, according to one embodiment of the present invention. Sharing functionality enables collaboration between the parties with the ability to annotate the shared content. For example, the user might be interacting with agent regarding an issue with their television and have questions about the warranty that came with their television. In one embodiment, the user shares a live view from the camera of their end user device 105, documents, photos from their photo library, interaction files, and/or even perform a live screen share with the agent. A file such as a document, photo, or image taken by the camera of the user's device 105 may be shared. In an example, the user shares a document with the agent regarding their TV warranty (1105a) by selecting the “document” option. In this example, both the agent and the customer may need to collaborate and annotate content as shown in 1105b (e.g., the user marks a section in support of their claim that the television is still under warranty, and in response, the agent may mark and annotate another section in response, to say that the warranty is void because of incorrect handling). Other files may also be shared, such as screenshots of content captured by one of the parties during the conversation, or a supporting file the user uploaded prior to the interaction.

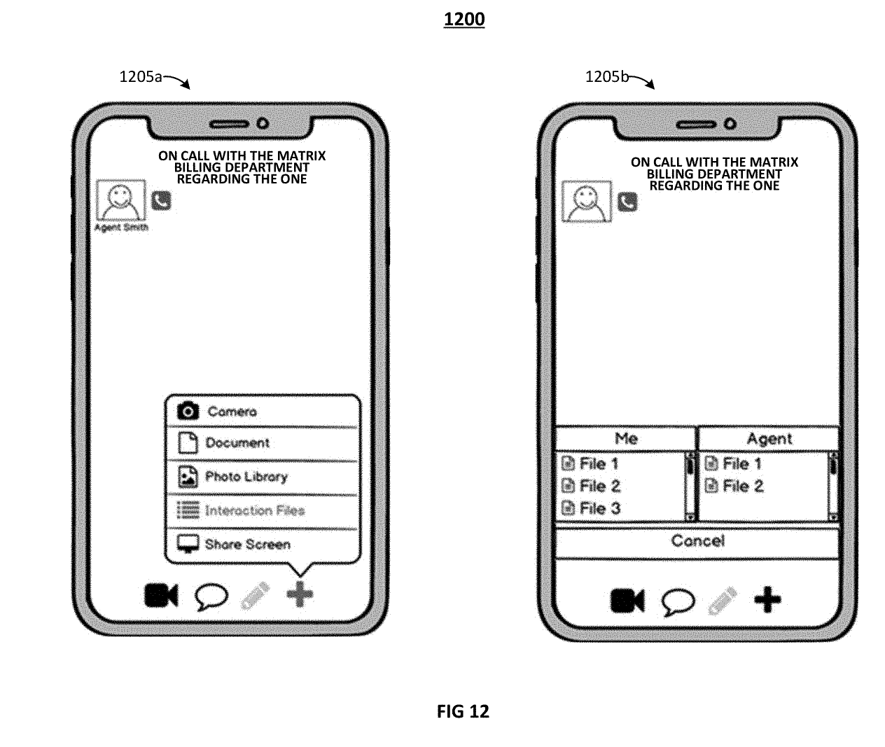

FIG. 12 is a diagram illustrating file sharing functionality, indicated generally at 1200, according to one embodiment of the present invention. For example, the user is “on call with the matrix billing department regarding the one”, the user selects to share interaction files with the agent 1205a. The interaction files may include, for example, files the user uploaded earlier in the pre-call stage in preparation for the live call. As shown in 1205b, in some embodiments, a user chooses to view a file that the agent has uploaded. The user interface presents options for the user to select any number of collaborative files that have been uploaded into the application by the agent and/or the user for the interaction. At any point during the interaction, both parties can mark and annotate the shared content for viewing by the other party. The user is also able to take screenshots of any of the shared content.

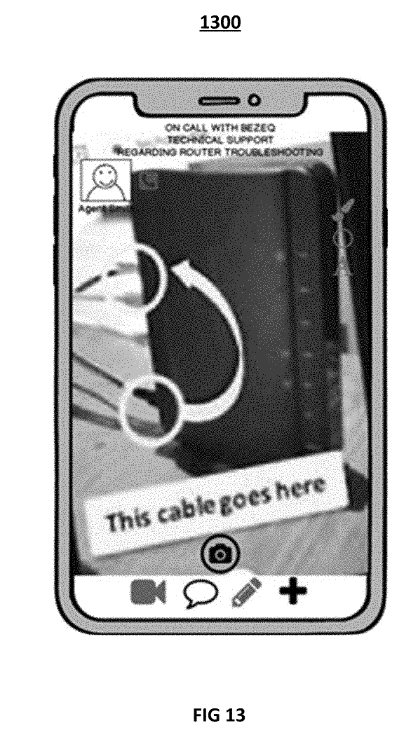

In an embodiment, the user shares the view from the camera on their mobile device (e.g., the end user device 105) with the agent. The agent has the ability to overlay digital information on top of the live video from the camera. This AR capability of the application allows the agent to provide the user with quick and painless technical support. FIG. 13 is a diagram illustrating an embodiment of overlay instructions, indicated generally at 1300. In this example, the user is having issues troubleshooting their router. The user may show the agent their technical issue via smartphone camera. The agent can overlay visual markings and annotations in real-time to guide the user to a solution. In FIG. 13, the agent has drawn circles and provided directions “This cable goes here.” As with content sharing functionality described above, the user is able to mark and annotate the live camera image and take a screenshot at any point during the conversation.

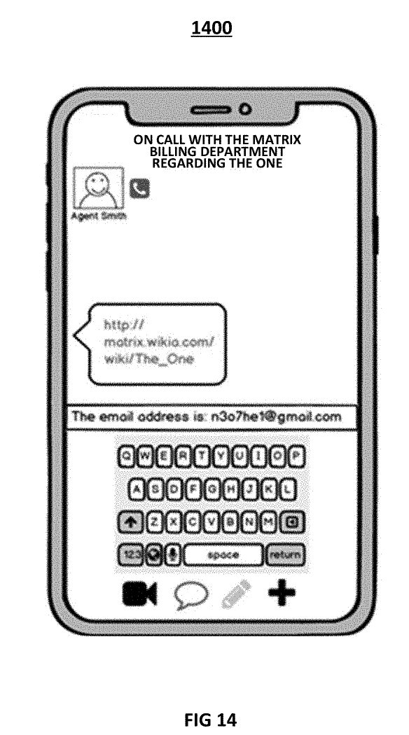

In some aspects of embodiments of the present invention, during an interaction (e.g., a call), the parties can send and receive messages (e.g., text messages) in the context of the interaction through the application (e.g., the customer experience automation system 200). FIG. 14 is a diagram illustrating an embodiment of a second channel of communication during an interaction, indicated generally at 1400. At any point during the interaction, the agent can send the user a link, for example, to a webpage on the provider's website in response to the user's spoken verbal inquiry. At some other unrelated point during the conversation, the user sends the agent his email address because this sort of information usually needs to be spelled out. It is easier for the agent to get the email address or to send the URL to a webpage, or another piece of important information in the form of text rather than voice due to similar sounding letters or other potential miscommunications.

In an embodiment, the customer experience automation system 200 monitors statements made by the contact center agent and automatically offers guidance to the user. For example, the customer experience automation system 200 converts the contact center agent's speech to text using the speech-to-text converter 240b (FIG. 2) and processes the text using the natural language processing module 210. In some embodiments, the natural language processing module 210 detects when the agent is making an offer and compares it to a database of other offers made by agents of the organization that the user is speaking with. In some embodiments, this database of other offers is crowdsourced from other users. After identifying a corresponding matching offer in the database, the ranking of the offer compared to other offers is identified in order to determine whether the agent could make a better offer. For example, a contact center agent may offer “Internet service at up to 400 MB a second for $39 a month.” Stored prior interactions between the company represented by the contact center agent and other users may include other offers made by other agents and other users. In some embodiments, the customer experience automation system 200 searches for offers corresponding to the same product (e.g., “internet service at 400 MB/sec”) and identifies the prices associated with these offers (e.g., ranging from $39 per month to $69 per month). After determining how the current offer fits within the range of offers made to other users (e.g., this price of $39 is at the low end of the range of prices), the customer experience automation system 200 may automatically make a recommendation to the user (e.g., by displaying the recommendation on the screen or by using the speech synthesizer 240a to generate a message) such as “this offer is the best offer that other customers have received.” Alternatively, in the case that the price offered is $59 per month, the recommendation may be “other users have received offers of $39 per month for the same service” to suggest that the user may be able to continue to negotiate. In some embodiments of the present invention, the ranking of the offers is also crowdsourced. For example, the offers may be displayed in the user interface and users can vote for the best offers to generate the rankings.

Post-Call

Some aspects of embodiments of the present invention relate to presenting information to the user about prior interactions. Such information may be retrieved during an interaction (e.g., to show a current agent what other agents have said) or may be retrieved between interactions.

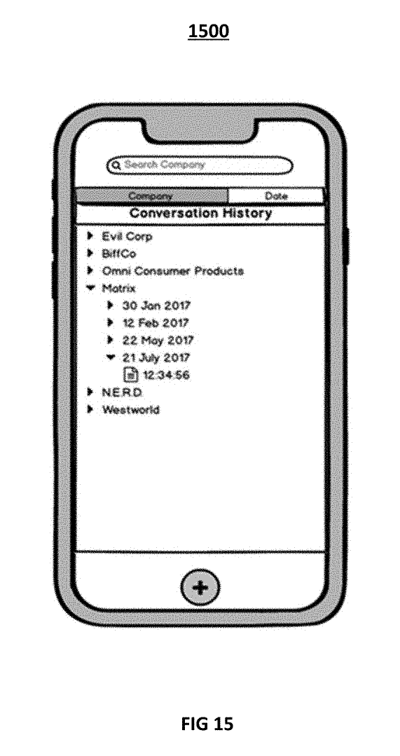

In an embodiment, once an interaction has concluded, the application 200 documents the interaction that the user had (e.g., storing the interaction as part of the user profile 230), along with other interactions that the user has had with any number of other providers. Different types of interactions may be tracked, including text, voice, and video, along with documents exchanged during the interactions (e.g., files shared with an agent). FIG. 15 is a diagram illustrating a history screen, indicated generally at 1500, according to one embodiment of the present invention. As illustrated in FIG. 15, the user has the ability to search their interaction history. From this UI, the user can search and navigate over their interactions with one or more different providers and agents. For example, the user has had four prior interactions with ‘Matrix’ on 30 Jan. 2017, 12 Feb. 2017, 22 May 2017, and 21 Jul. 2017. Additionally, the user has interacted with contact centers associated with providers EvilCorp, BiffCo, Omni Consumer Products, N.E.R.D., and Westworld. The user is able to select any of these providers and view the associated interactions and any other information provided during those interactions. For example, the user may search for keywords spoken by the agent in order to retrieve the audio near the keywords in addition to other media or files that were active while the document was active. As a specific example, after conducting a technical support call, the user may want to find the image that was annotated by the contact center agent when the agent was explaining how to set up the cables of the modem. As such, the user may search for the words “modem cable” in the transcript of the interaction, and the application 200 may display a transcript of the portion of the interaction that contains the query words, along with a view of the screen (e.g., the document being shared) at the corresponding timestamp of the portion of the interaction containing the matching query words in order to retrieve the image 1300 (see, e.g., FIG. 13).

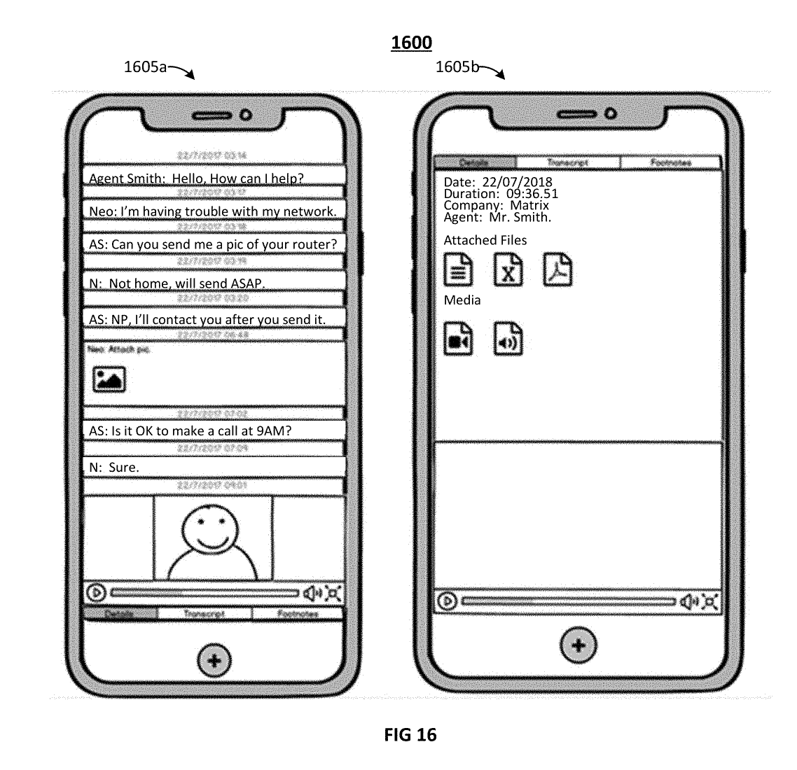

FIG. 16 is a diagram illustrating a history screen, indicated generally at 1600, according to one embodiment of the present invention. An exemplary documented interaction between an agent of a contact center and a user is illustrated at 1600. The documented interaction stored by the application (e.g., application 200, storing the interaction in the user profile 230) includes all messages and documents (e.g., files and media) involved in the interaction. Referring to FIG. 16, in 1605a, a transcript is provided of the interaction. In one embodiment, the user is able to view specific details of the interaction such as the timing of lines in the conversation as well as what files were shared and when those files were shared. Other information may be provided such as details and footnotes, as illustrated in 1605b. Files and media associated with the interaction may also be presented to the user. The user may also be able to obtain some metadata information regarding the interaction, such as the date and duration of the interaction, the name of the agent, and the name of the organization or company involved. In some embodiments of the present invention, the application 200 provides a UI for the user to annotate the interactions, such as rating interactions with a “thumbs up” (positive) or “thumbs down” (negative) rating, adding notes to portion of the interaction, and marking particular portions (e.g., particular time or ranges of time, as indicated by timestamps) of the interaction as “good” or “bad.”

Privacy Control

Some aspects of embodiments of the present invention are directed to enabling the user to manage data sharing with organizations (e.g., companies or service providers). The user may manage data sharing globally across all providers and all data types. The user may manage data sharing on a per-organization basis by choosing which data type to share with a specific organization. The user may also manage their data (e.g., their user profile) by data type by choosing with which provider to share each particular data type. In more detail, each field of data in the user profile is associated with at least one permission setting (e.g., in some embodiments, each field of data may have a different permission setting for each provider). The application may offer a plurality of levels of sharing for each permission setting. According to one embodiment, three different levels of sharing (e.g., permission level) are offered: share data, share anonymous data, and do not share at all. Anonymous data includes, for example, genericized information about the user such as gender, zip code of residence, salary band, etc. (e.g., male, living in zip code 94131, making between $100,000 and $199,999).

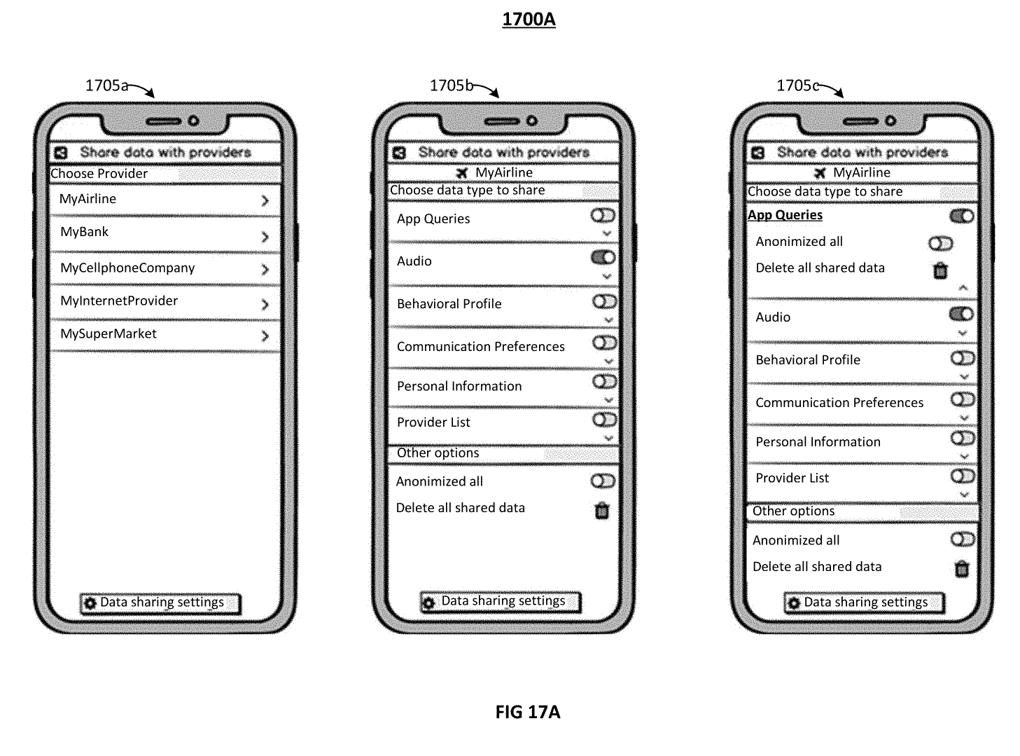

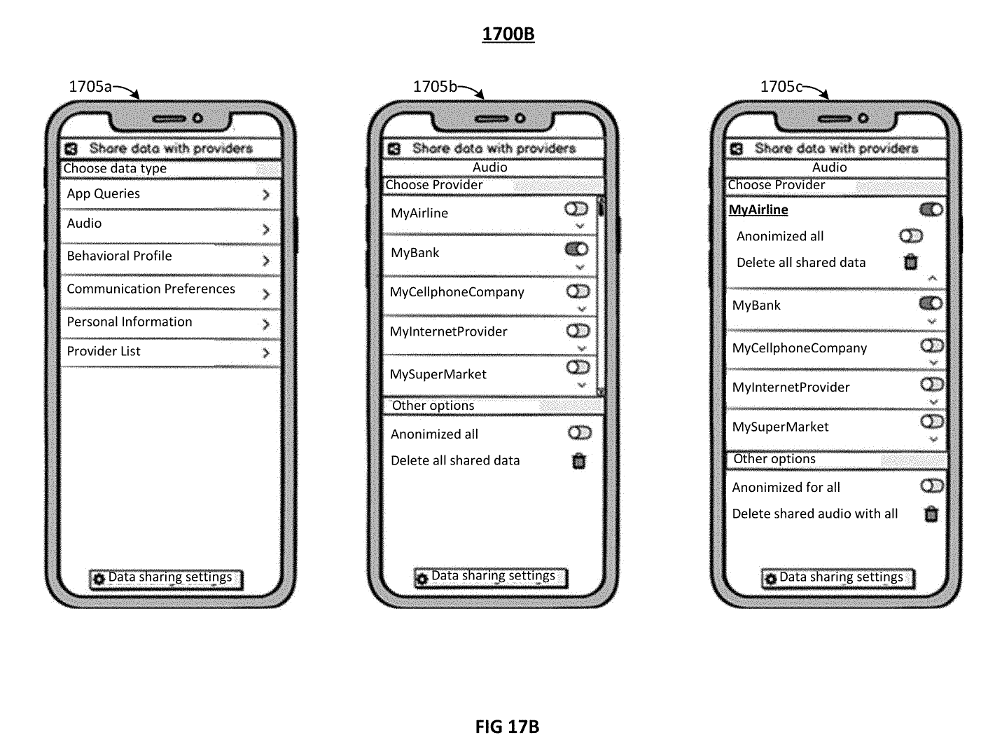

Some aspects of embodiments of the present invention enable compliance with the General Data Protection Regulation (GDPR) of the European Union (EU). In an embodiment of the present invention, the application provides functionality for a user to exercise the “right to be forgotten” with all of the organizations (e.g., providers and/or business) that the user has interacted with. Sharing settings and a deleting option may be available for each data type and for each provider. FIG. 17A is a diagram illustrating an embodiment of data sharing control, indicated generally at 1700A. The user can choose a provider from their providers (organizations) list in 1705a. In this example, the user selects the provider ‘MyAirLine.’ The user reaches a screen similar to 1705b which shows a list of all of the data types that can be shared with the selected provider (‘MyAirLine’). There, the user can switch on or off the sharing of each of the data types. When selecting a specific data type, such as ‘App queries,’ the user can select to send this data in an anonymized form to the provider or to delete the previously shared data with this provider 1705c. Additionally, the user can delete all data types that were previously shared with ‘MyAirLine’ by clicking on the ‘trash’ button provided in the user interface. According to one embodiment of the present invention, the deletion of the data may include loading an appropriate script from the script storage 220 in order to generate a formal request to the associated organization to delete the specified data. As noted above, for example, the request may be made by initiating a communication with a live agent of the organization or by accessing an application programming interface provided by the organization.

The user may also access the settings of a specific data type as seen in FIG. 17B. FIG. 17B is a diagram illustrating data sharing control, indicated generally at 1700B, according to one embodiment of the present invention. The user is presented with a plurality of data types in 1705d. For example, the user may be shown ‘App queries,’ ‘Audio,’ ‘Behavioral profile,’ ‘Communication preferences,’ ‘Personal information,’ and ‘Provider list.’ The user may select one of these data types. In this example, the user selects the data type ‘Audio’ and is taken to the screen shown in 1705e which shows a list of all the providers that offer sharing of this data type. The user can switch on or off the sharing of this data type with each of the providers. When clicking on a specific provider (e.g., ‘MyAirLine’), the user can choose to send this data anonymized to the provider or delete the previously shared data with the provider 1705f. The user may also delete all the ‘Audio’ data types that were previously shared with any of the providers by selecting the ‘trash’ button provided in the user interface. As noted above, according to one embodiment of the present invention, the deletion of the data may include loading appropriate scripts from the script storage 220 in order to generate a formal request to each associated organization to delete the specified data from each organization.

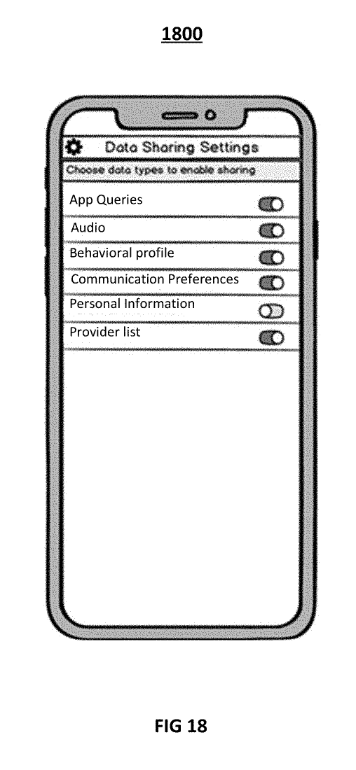

In addition to editing all of these settings per provider and per data type, according to some embodiments of the present invention, the user can edit the data sharing settings globally in the data sharing settings screen. FIG. 18 is a diagram illustrating data sharing control, indicated generally at 1800, according to one embodiment of the present invention. Here, the user is shown a listing of all the data types (App Queries, Audio, Behavioral profile, Communication preferences, Personal Information, Provider list). The user can switch on/off the sharing of each data type globally, which means the sharing of this data type will be enabled for all providers. In this example shown in FIG. 18, the user has turned off sharing of Personal Information.

Personalized Agent Learning

Some aspects of embodiments of the present invention relate to automatically learning characteristics of the user's preferred agents. These characteristics may include behavior, language, age, gender, and the like, based on sentiment analysis of the user when speaking with agents having different characteristics and/or based on the user's rating of prior interactions through the user interface described above (e.g., “thumbs up” versus “thumbs down”). According to some embodiments of the present invention, the application transmits the user's preferences to the contact center, and the contact center may apply the user's preferences as a factor when routing the interaction to an agent.

Computer Systems

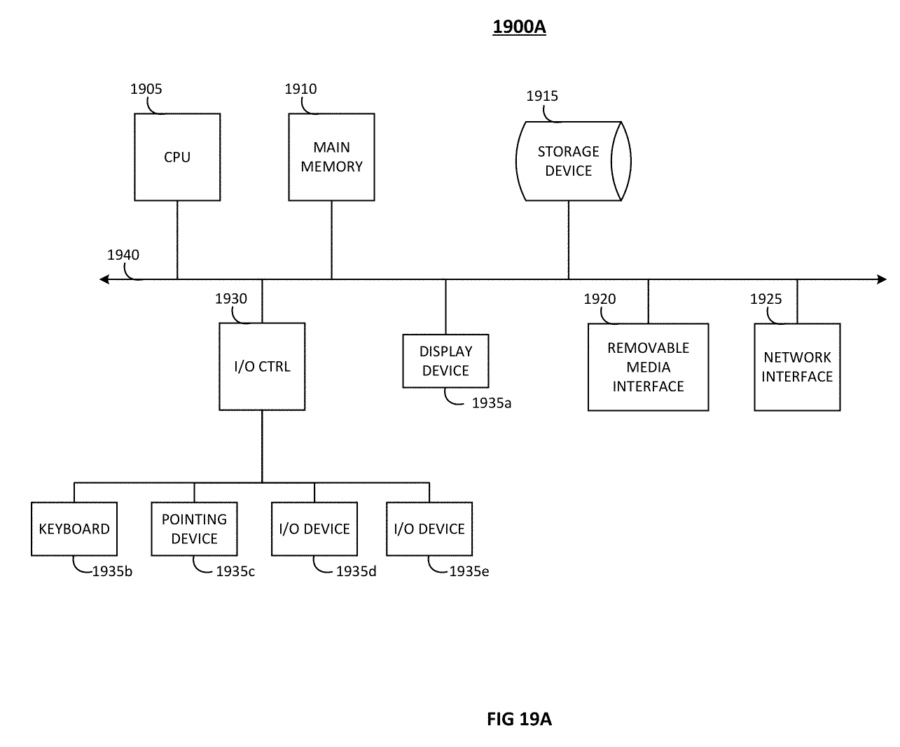

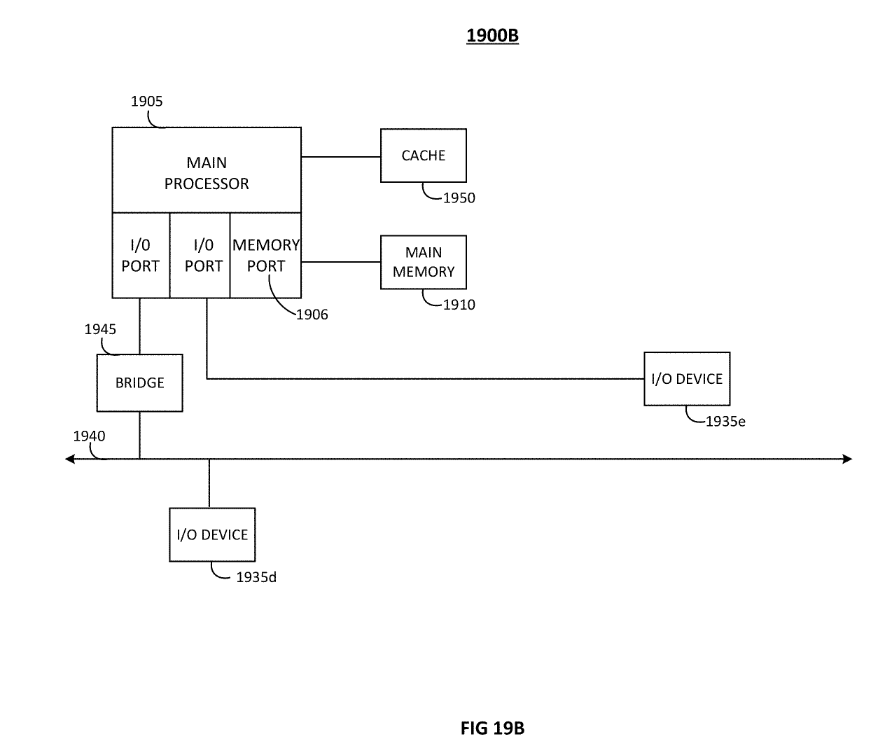

Each of the various servers in the contact center, portions of the customer experience automation system 200 operating on a cloud based server, and portions of the customer experience automation system 200 operating on an end user device 105 may be a process or thread, running on one or more processors, in one or more computing devices 1900 (e.g., FIG. 19A, FIG. 19B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers and other modules.

Each of the various servers, controllers, switches, and/or gateways in the afore-described figures may be a process or thread, running on one or more processors, in one or more computing devices 1900 (e.g., FIG. 19A, FIG. 19B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

FIG. 19A and FIG. 19B depict block diagrams of a computing device 1900 as may be employed in exemplary embodiments of the present invention. Each computing device 1900 includes a central processing unit 1905 and a main memory unit 1910. As shown in FIG. 19A, the computing device 1900 may also include a storage device 1915, a removable media interface 1920, a network interface 1925, an input/output (I/O) controller 1930, one or more display devices 1935c, a keyboard 1935a and a pointing device 1935b, such as a mouse. The storage device 1915 may include, without limitation, storage for an operating system and software. As shown in FIG. 19B, each computing device 1900 may also include additional optional elements, such as a memory port 1906, a bridge 1945, one or more additional input/output devices 1935d, 1935e and a cache memory 1950 in communication with the central processing unit 1905. The input/output devices 1935a, 1935b, 1935d, and 1935e may collectively be referred to herein using reference numeral 1935.

The central processing unit 1905 is any logic circuitry that responds to and processes instructions fetched from the main memory unit 1910. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1910 may be one or more memory chips capable of storing data and allowing any storage location to be directly accessed by the central processing unit 1905. As shown in FIG. 19A, the central processing unit 1905 communicates with the main memory 1910 via a system bus 1940. As shown in FIG. 19B, the central processing unit 1905 may also communicate directly with the main memory 1910 via a memory port 1906.

FIG. 19B depicts an embodiment in which the central processing unit 1905 communicates directly with cache memory 1950 via a secondary bus, sometimes referred to as a backside bus. In other embodiments, the central processing unit 1905 communicates with the cache memory 1950 using the system bus 1940. The cache memory 1950 typically has a faster response time than main memory 1910. As shown in FIG. 19A, the central processing unit 1905 communicates with various I/O devices 1935 via the local system bus 1940. Various buses may be used as the local system bus 1940, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1935c, the central processing unit 1905 may communicate with the display device 1935c through an Advanced Graphics Port (AGP). FIG. 19B depicts an embodiment of a computer 1900 in which the central processing unit 1905 communicates directly with I/O device 1935e. FIG. 19B also depicts an embodiment in which local busses and direct communication are mixed: the central processing unit 1905 communicates with I/O device 1935d using a local system bus 1940 while communicating with I/O device 1935e directly.

A wide variety of I/O devices 1935 may be present in the computing device 1900. Input devices include one or more keyboards 1935a, mice, trackpads, trackballs, microphones, and drawing tablets. Output devices include video display devices 1935c, speakers, and printers. An I/O controller 1930, as shown in FIG. 19A, may control the I/O devices. The I/O controller may control one or more I/O devices such as a keyboard 1935a and a pointing device 1935b, e.g., a mouse or optical pen.

Referring again to FIG. 19A, the computing device 1900 may support one or more removable media interfaces 1920, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1935 may be a bridge between the system bus 1940 and a removable media interface 1920.

The removable media interface 1920 may for example be used for installing software and programs. The computing device 1900 may further include a storage device 1915, such as one or more hard disk drives or hard disk drive arrays, for storing an operating system and other related software, and for storing application software programs. Optionally, a removable media interface 1920 may also be used as the storage device. For example, the operating system and the software may be run from a bootable medium, for example, a bootable CD.

In some embodiments, the computing device 1900 may include or be connected to multiple display devices 1935c, which each may be of the same or different type and/or form. As such, any of the I/O devices 1935 and/or the I/O controller 1930 may include any type and/or form of suitable hardware, software, or combination of hardware and software to support, enable or provide for the connection to, and use of, multiple display devices 1935c by the computing device 1900. For example, the computing device 1900 may include any type and/or form of video adapter, video card, driver, and/or library to interface, communicate, connect or otherwise use the display devices 1935c. In one embodiment, a video adapter may include multiple connectors to interface to multiple display devices 1935c. In other embodiments, the computing device 1900 may include multiple video adapters, with each video adapter connected to one or more of the display devices 1935c. In some embodiments, any portion of the operating system of the computing device 1900 may be configured for using multiple display devices 1935c. In other embodiments, one or more of the display devices 1935c may be provided by one or more other computing devices, connected, for example, to the computing device 1900 via a network. These embodiments may include any type of software designed and constructed to use the display device of another computing device as a second display device 1935c for the computing device 1900. One of ordinary skill in the art will recognize and appreciate the various ways and embodiments that a computing device 1900 may be configured to have multiple display devices 1935c.

A computing device 1900 of the sort depicted in FIG. 19A and FIG. 19B may operate under the control of an operating system, which controls scheduling of tasks and access to system resources. The computing device 1900 may be running any operating system, any embedded operating system, any real-time operating system, any open source operating system, any proprietary operating system, any operating systems for mobile computing devices, or any other operating system capable of running on the computing device and performing the operations described herein.

The computing device 1900 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1900 may have different processors, operating systems, and input devices consistent with the device.

In other embodiments the computing device 1900 is a mobile device, such as a Java-enabled cellular telephone or personal digital assistant (PDA), a smart phone, a digital audio player, or a portable media player. In some embodiments, the computing device 1900 includes a combination of devices, such as a mobile phone combined with a digital audio player or portable media player.

In an embodiment, the CPU 1905 may include a plurality of processors and may provide functionality for simultaneous execution of instructions or for simultaneous execution of one instruction on more than one piece of data. In an embodiment, the computing device 1900 may include a parallel processor with one or more cores. In an embodiment, the computing device 1900 comprises a shared memory parallel device, with multiple processors and/or multiple processor cores, accessing all available memory as a single global address space. In another embodiment, the computing device 1900 is a distributed memory parallel device with multiple processors each accessing local memory only. The computing device 1900 may have both some memory which is shared and some which may only be accessed by particular processors or subsets of processors. The CPU 1905 may include a multicore microprocessor, which combines two or more independent processors into a single package, e.g., into a single integrated circuit (IC). For example, the computing device 1900 may include at least one CPU 1905 and at least one graphics processing unit.

In an embodiment, a CPU 1905 provides single instruction multiple data (SIMD) functionality, e.g., execution of a single instruction simultaneously on multiple pieces of data. In another embodiment, several processors in the CPU 1905 may provide functionality for execution of multiple instructions simultaneously on multiple pieces of data (MIMD). The CPU 1905 may also use any combination of SIMD and MIMD cores in a single device.

A computing device 1900 may be one of a plurality of machines connected by a network, or it may include a plurality of machines so connected. A network environment may include one or more local machines, client(s), client node(s), client machine(s), client computer(s), client device(s), endpoint(s), or endpoint node(s)) in communication with one or more remote machines (also generally referred to as server machine(s) or remote machine(s)) via one or more networks. In an embodiment, a local machine has the capacity to function as both a client node seeking access to resources provided by a server machine and as a server machine providing access to hosted resources for other clients. The network may be a local-area network (LAN), e.g., a private network such as a company Intranet, a metropolitan area network (MAN), or a wide area network (WAN), such as the Internet, or another public network, or a combination thereof. Connections may be established using a variety of communication protocols. In one embodiment, the computing device 1900 communicates with other computing devices 1900 via any type and/or form of gateway or tunneling protocol such as Secure Socket Layer (SSL) or Transport Layer Security (TLS). The network interface 1925 may include a built-in network adapter, such as a network interface card, suitable for interfacing the computing device 1900 to any type of network capable of communication and performing the operations described herein. An I/O device 1935 may be a bridge between the system bus 1940 and an external communication bus.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A method for automating an interaction between a user and a contact center, the method comprising:
receiving, by a processor, a natural language inquiry from the user;
identifying, by the processor, a user intent from the natural language inquiry using a natural language processing module;
loading, by the processor, a script corresponding to the user intent, the script comprising a plurality of fields of information associated with the user intent;
filling at least one of the fields of information of the script based on a stored user profile; and
supplying the filled fields of information to the contact center in accordance with the script.

2. The method of claim 1, further comprising:
prompting the user for data to fill at least one of the fields of information of the script; and
receiving the data from the user to fill the at least one of the fields of information.

3. The method of claim 1, wherein at least one of the fields of information comprises user authentication information.

4. The method of claim 1, wherein the supplying the filled fields of information comprises supplying the filled fields of information to a text-to-speech converter to generate speech and transmitting the generated speech in accordance with an interaction script to a voice communication channel with the contact center.

5. The method of claim 4, wherein the interaction script is mined from a plurality of historical interactions between customers and the contact center.

6. The method of claim 1, wherein the supplying the filled fields of information comprises transmitting the filled fields of information in accordance with an application programming interface associated with the contact center.

7. The method of claim 1, wherein the supplying the filled fields of information comprises navigating an interactive voice response system of the contact center.

8. The method of claim 1, further comprising:
establishing a communication channel with an agent of the contact center after supplying the filled fields of information to the contact center; and
connecting the user to the contact center via the communication channel.

9. The method of claim 8, further comprising detecting an indication from the agent of the contact center that the agent is ready to speak to the user,
wherein the connecting the user to the contact center via the communication channel occurs after detecting the indication from the agent of the contact center.

10. The method of claim 1, further comprising displaying one or more recommended actions to the user,
wherein the one or more recommended actions are automatically extracted from a plurality of historical interactions between users and the contact center by:
identifying a plurality of interactions having a same user intent;
identifying successful and unsuccessful interactions from among the plurality of interactions having the same user intent;
identifying characteristics of successful interactions; and
generating recommendations based on the identified characteristics of successful interactions.

11. The method of claim 1, wherein the one or more fields comprise user preferences for agent characteristics.

12. The method of claim 1, wherein the stored user profile comprises a plurality of fields of data, and
wherein each field of the stored user profile is associated with at least one permission setting, the at least one permission setting being set to one of a plurality of sharing levels, the plurality of sharing levels comprising:
share data;
share anonymous data; and
do not share.

13. A system for automating an interaction between a user and a contact center, the system comprising:
a processor;
a user interface device coupled to the processor; and
memory storing instructions that, when executed by the processor, cause the processor to:
receive a natural language inquiry from the user via the user interface device;
identify a user intent from the natural language inquiry using a natural language processing module;
load a script corresponding to the user intent, the script comprising a plurality of fields of information associated with the user intent;
fill at least one of the fields of information of the script based on a stored user profile; and
supply the filled fields of information to the contact center in accordance with the script.

14. The system of claim 13, wherein the memory further stores instructions that, when executed by the processor, cause the processor to:
prompt the user for data to fill at least one of the fields of information of the script via the user interface device; and
receive the data from the user to fill the at least one of the fields of information.

15. The system of claim 13, wherein at least one of the fields of information comprises user authentication information.

16. The system of claim 13, wherein the instructions that cause the processor to supply the filled fields of information comprise instructions that, when executed by the processor, cause the processor to:
supply the filled fields of information to a text-to-speech converter to generate speech; and
transmit the generated speech in accordance with an interaction script to a voice communication channel with the contact center.

17. The system of claim 16, wherein the interaction script is mined from a plurality of historical interactions between customers and the contact center.

18. The system of claim 17, wherein the instructions that cause the processor to supply the −filled fields of information comprise instructions that, when executed by the processor, cause the processor to transmit the filled fields of information in accordance with an application programming interface associated with the contact center.

19. The system of claim 13, wherein the instructions that cause the processor to supply the filled fields of information comprise instructions that, when executed by the processor, cause the processor to navigate an interactive voice response system of the contact center.

20. The system of claim 13, wherein the memory further stores instructions that, when executed by the processor, cause the processor to:
establish a communication channel with an agent of the contact center after supplying the filled fields of information to the contact center; and
connect the user to the contact center via the communication channel.

21. The system of claim 20, wherein the memory further stores instructions that, when executed by the processor, cause the processor to detect an indication from the agent of the contact center that the agent is ready to speak to the user,
wherein the instructions that cause the processor to connect the user to the contact center via the communication channel are executed after detecting the indication from the agent of the contact center.

22. The system of claim 13, wherein the memory further stores instructions that, when executed by the processor, cause the processor to display one or more recommended actions to the user, and
wherein the one or more recommended actions are automatically extracted from a plurality of historical interactions between users and the contact center by:
identifying a plurality of interactions having a same user intent;
identifying successful and unsuccessful interactions from among the plurality of interactions having the same user intent;
identifying characteristics of successful interactions; and
generating recommendations based on the identified characteristics of successful interactions.

23. The system of claim 13, wherein the one or more fields comprise user preferences for agent characteristics.

24. The system of claim 13, wherein the stored user profile comprises a plurality of fields of data, and
wherein each field of the stored user profile is associated with at least one permission setting, the at least one permission setting being set to one of a plurality of sharing levels, the plurality of sharing levels comprising:
share data;
share anonymous data; and
do not share.
